(19) United States
(12) Patent Application Publication
(10) Pub. No.: US 2025/0238699 A1
(43) Pub. Date: Jul. 24, 2025

(54) A COMPUTER-IMPLEMENTED METHOD FOR DETERMINING A CONTROL SEQUENCE FOR PERFORMING A SERIES OF QUBIT INTERACTIONS, A COMPUTER PROGRAM PRODUCT, A QUANTUM CIRCUIT, AND A METHOD FOR DETERMINING A CHARACTERISTIC OF A SYSTEM

(71) Applicant: IQM FINLAND OY, Espoo (FI)

(72) Inventors: Fedor ŠIMKOVIC, München (DE); Manuel GARCÍA PÉREZ DE ALGABA, München (DE); Pallasena Viswanathan SRILUCKSHMY, München (DE); Martin LEIB, München (DE)

(21) Appl. No.: 18/846,134

(22) PCT Filed: Feb. 2, 2023
(86) PCT No.: PCT/FI2023/050067

§ 371 Date: Sep. 11, 2024

(30) Foreign Application Priority Data
Mar. 14, 2022 (WO) PCT/FI2022/050163

(51) Int. Cl. G06N 10/20; G06N 10/40

(52) U.S. Cl. CPC G06N 10/20; G06N 10/40

(57) ABSTRACT

A computer-implemented method for determining a control sequence for performing a sequence of steps acting on qubits on a plurality of qubits on a quantum device, the method comprising obtaining a plurality of qubit entities, decomposing at least one qubit entity, combining at least two qubit entities, and compressing at least one determined combination of at least two qubit entities.

### TECHNICAL FIELD OF THE INVENTION

The invention relates to quantum devices in general. More specifically, the invention relates to determining a series of qubit interactions to be implemented on quantum devices by utilizing decomposition and compression of qubit entities, such as qubit operators.

### BACKGROUND OF THE INVENTION

Quantum computers can provide powerful tools for studying various types of problems, such as many-body problems, where Hamiltonian equations can be used to study the properties of a quantum many-body system, whereby for instance the electronic structure of a molecule may be determined.

While quantum computers are well suited for simulation of quantum many-body systems, current quantum computers are limited by errors in the form of noise, faults and loss of quantum coherence. Accuracy of quantum computation results may decrease rapidly as the number of gate operations, and circuit depth increase.

Furthermore, although quantum error correction can be used in quantum computing to protect quantum information from errors due to decoherence and other quantum noise, quantum error correction requires additional qubits, the number of which are limited by the total available number of qubits. A problem associated with some of the known methods for simulating many-body interactions is the use of ancillary spins, which further reduces the number of remaining available qubits.

In particular, studies of fermionic quantum systems that can be characterized by fermionic Hamiltonians are important in many fields of technologies, such as study of superconductivity, battery design, chemical reaction optimization, fertilizers, and novel drugs.

Before simulation of a quantum many-body system, the interactions that are to be implemented shall be translated into qubit interactions. The e.g. fermionic interactions may be expressed as qubit interactions involving a plurality of qubits. To be able to carry out computations on a quantum device, however, these multi-qubit interactions may need to be expressed as one- and/or two-qubit interactions.

Some prior art methods also utilize a plurality of CNOT gates for solving many-body problems. One problem with such an approach in digital quantum computing is that CNOT gates are not always native for all of the qubit pairs in currently available quantum systems. Gates that are not native to the system need to be decomposed into a sequence of native gates, thus resulting in a higher number of gates used.

When a computation is performed on a quantum device, a quantum circuit is implemented, where the quantum circuit comprises a sequence of quantum gates, which may correspond to qubit interactions or qubit operators, that describe the interactions between qubits that are to be carried out. Due to the accuracy of the result of the computation being influenced by the number of gates that are implemented and/or a depth (number of layers) in the quantum circuit, it is advantageous to attempt to find ways to provide quantum circuits that have a circuit depth and/or number of quantum gates that is as low as possible and/or to provide ways to reduce the circuit depth and/or number of quantum gates associated with a certain problem.

### SUMMARY OF THE INVENTION

An object of the invention is to alleviate at least some of the problems of the prior art. In accordance with one aspect of the present invention a computer-implemented method for determining a control sequence for performing a series of steps acting on a plurality of qubits on a quantum device, the method comprising:
obtaining a plurality of qubit entities, comprising at least a first qubit entity and a second qubit entity, wherein a qubit entity comprises a sequence of steps acting on qubits, and wherein at least said second qubit entity comprises a single multi-qubit interaction term,
decomposing the multi-qubit interaction term of the second qubit entity and determining a decomposed sequence of steps acting on qubits, so that the multi-qubit interaction term has been decomposed into a sequence of single qubit and/or two-qubit interaction terms,
combining the first sequence of steps acting on qubits of the first qubit entity with the decomposed sequence of steps acting on qubits of the second qubit entity to obtain a combined sequence of steps acting on qubits,
compressing the combined sequence of steps acting on qubits to provide a compressed sequence of steps acting on qubits comprising only single-qubit and/or two-qubit interactions, wherein a number of steps acting on qubits in the compressed sequence of steps acting on qubits is less than or equal to the number of steps acting on qubits in the combined sequence of steps acting on qubits, and
providing a control sequence for performing a sequence of steps acting on qubits, said control sequence comprising at least the compressed sequence of steps acting on qubits.

In this text, the terms “operator”, “interaction”, and “gate” may be used interchangeably. The terms “control sequence” and “quantum circuit” or “circuit” may be used interchangeably. A “series” or “sequence” of “steps acting on qubits” may also herein refer to a quantum circuit, where such series or sequence comprises steps, each step being defined as a time interval during which a qubit interaction is to be implemented between qubits specified by the series. The series of steps acting on qubits may thus comprise e.g. two-qubits gates, specifying the qubits which are acted on, and an order in which the gates are to be implemented with respect to time. A circuit may also refer to an empty circuit, comprising one or more steps where no qubit interactions are to be implemented.

With the present invention, a solution for providing many-body or multi-qubit gates by using native two-qubit gates (TQGs) (or possibly native single-qubit gates (SQGs) and TQGs may be provided. This may be advantageous as compared to solutions where CNOT gates are utilized.

In embodiments of the method, a final control sequence may comprise both SQGs and TQGs.

The number of gates, specifically preferably TQGs, required for carrying out multi-qubit interactions may be reduced by at least one when compared to prior art approaches. Additionally, or alternatively, a circuit depth of the quantum circuit that is provided through the control sequence may be reduced as compared to prior art methods where the same many-body problem is solved.

A depth of a quantum circuit may refer to the number of time steps required for its completion. Therefore, reduction of circuit depth may result, in addition to reduced computation time, reduced errors, as quantum computations may involve increased error as the time required for computation is increased.

The present invention may provide a method (or a quantum compiler) for determining a control sequence that may be used to implement multi-qubit interactions on a quantum device, such that a resulting circuit depth is lower than using other prior art methods. Decomposing of at least one qubit entity, which corresponds to a single multi-qubit operator or interaction, into a series of two-qubit interactions or a combination of SQGs and TQGs, by iterative decomposition may yield a control sequence that leads to a lower circuit depth that the prior art methods.

Even further reduction of circuit depth may be provided when a decomposed qubit entity which has previously been a single multi-qubit entity, namely before the decomposition, is combined with another qubit entity, further where the combination is compressed to provide a compressed circuit. The circuit depth of the compressed circuit may be shorter than the circuit depth of circuit that is obtained by only decomposing and combining the qubit entities. The method may provide an advantageous way of providing a quantum circuit that implements a plurality of multi-qubit operators or combines decomposed multi-qubit operators into compressed quantum circuits, such that a low circuit depth is provided.

The first qubit entity may comprise a first sequence of steps acting on qubits comprising steps comprising single and/or two-qubit interaction terms and/or no interactions between qubits. When the sequence of steps acting on qubits of the first qubit entity comprises only steps with no interactions between qubits, the first qubit entity is considered an empty quantum circuit. Yet, in an alternative, the first qubit entity can comprise only single-qubit interaction terms or only two-qubit interaction terms or a combination of single and two-qubit interaction terms.

In a simplest use case scenario, a first qubit entity may be an empty quantum circuit and a second qubit entity may be a single multi-qubit operator, where the second qubit entity e.g. corresponds to a Hamiltonian operator containing only a single term, where no further qubit entities are considered.

In some embodiments, if a first qubit entity being a quantum circuit comprising single and/or two qubit-interaction terms is not obtained, but e.g. all inputs comprise single multi-qubit interaction terms, the first qubit entity may be generated by decomposing one of the multi-qubit interaction terms to determine a first sequence of steps acting on qubits that is a quantum circuit comprising single and/or two qubit-interaction terms, that is then to be used in combining and compressing together with a second qubit entity.

According to one embodiment, the first qubit entity may be considered as an “empty circuit” that is generated by the first computing device that is combined with an obtained second qubit entity that is first decomposed to provide a decomposed quantum circuit and the combination is compressed. Any obtained further single multi-qubit operators may be considered as subsequent or further qubit entities.

The plurality of qubit entities may thus comprise at least one subsequent qubit entity, said subsequent qubit entity comprises a single multi-qubit interaction term, wherein the method comprises decomposing the subsequent qubit entity to determine a subsequent decomposed sequence of steps acting on qubits of the subsequent qubit entity, which is combined with the compressed sequence of steps acting on qubits which has been determined in a previous compression, determining a final sequence of steps acting on qubits as the compressed sequence of steps acting on qubits determined in the last performed compression.

A subsequent qubit entity may be decomposed using the same decomposition as the compressed sequence of steps acting on qubits which has been determined in a previous compression.

A subsequent qubit entity may be decomposed suing a different decomposition as the compressed sequence of steps acting on qubits which has been determined in a previous compression.

The decomposing may comprise iterative decomposition steps of multi-qubit interaction terms, wherein each decomposition step comprises at least one interaction term comprising less qubits than an interaction term of a previous decomposition step.

A final decomposition step of the decomposing of the multiqubit interaction terms may comprise a final decomposed sequence of steps comprising at least a sequence of three two-qubit interaction terms, said final decomposition step being the last decomposition step done before combining.

The method may additionally comprise obtaining information indicative of native interactions of the quantum device, the method comprising applying single-qubit interactions in connection with two-qubit interactions that do not correspond to native gates of the quantum device to obtain single-qubit and/or two-qubit interactions terms that correspond to native interactions of the quantum device.

The compression may comprise performing at least one action selected from the group of commuting through, cancelling, shifting, reconstructing or merging into a single two-qubit operator, said action being performed for at least one pair of adjacent one or two qubit-operators adjacent two-qubit operators acting on at least one same qubit and/or for adjacent steps acting on qubits.

The compression may be carried out recursively. The compression may be a combination of any of the different type of actions, and any type of action can be repeated until the compressed sequence is no more compressible, meaning the different type of action do not have any effect anymore on the interaction terms in the sequence of step of the compressed sequence, and the depth of the compressed sequence can not be reduced anymore.

The compression may comprise performing at least an action of shifting an operator to an adjacent step.

The compression may comprise at least one action of cancelling and/or merging into a single two-qubit operator and/or cancelling, optionally in combination with at least one further action of cancelling, shifting, or merging into a single two-qubit operator.

The compression may comprise at least two two-qubit gates acting on the same qubits being compressed to a single two-qubit gate.

The compression may comprise at least two two-qubit gates acting on at least one common qubit being compressed to a single qubit gate and a two-qubit gate.

The compression may comprise an action of commuting at least two gates.

The compression may comprise an action of reconstructing at least one two-qubit gate and at least one single qubit-gate.

The decomposing may comprise determining a decomposed sequence of steps acting on qubits that is combinable with the first sequence of steps acting on qubits to obtain a plurality of commuting pairs of two-qubit interaction terms.

The decomposing may comprise decomposing a multi-qubit interaction term into a sequence of three interaction terms, a first interaction term described by a unitary e^{iuO} of a primary operator O where u is a coupling strength coefficient of O between the qubits on which the primary operator O acts, a second interaction term described by a unitary e^{iγH} of an auxiliary operator H, and a third interaction term described by a unitary e^{-iuO} of the negative of the primary operator −O, wherein H and O are each a tensor product of at least two Pauli matrices, the method comprising iterative decomposition of interaction terms relating to primary operators and auxiliary operators until the multi-qubit interaction term has been decomposed into a sequence of two-qubit interaction terms, wherein the multi-qubit interaction term of the first decomposition step is described by a unitary e^{iγH}^{_{d}} of the first multi-qubit operator and/or the second multi-qubit operator, where H_{d} refers to the multi-qubit operator being decomposed, and where γ is a coupling strength coefficient of H_{d}, and the multi-qubit interaction term in any subsequent decomposition step(s) relates to a primary operator O or an auxiliary operator H.

The method may then also comprise:
selecting at least one of the identified qubits as a central qubit,
selecting a first auxiliary operator H as a tensor product of M_{H} Pauli matrices, where each Pauli matrix in the tensor product acts on a different qubit, said qubits selected from those specified by the operator H_{d} and the selection including the at least one central qubit, and where M_{H} is less than the number M of Pauli matrices of the multi-qubit operator being decomposed,
selecting a first primary operator O as a tensor product of M_{O} Pauli matrices, where M_{O} is less than the number of Pauli matrices of the multi-qubit operator being decomposed and where each Pauli matrix in the tensor product acts on a different qubit, said qubits and Pauli matrices of the first primary operator O selected such that at least one qubit involved in the first primary operator O is one of the least one central qubits and H_{d} is proportional to the commutator of the primary operator O and the auxiliary operator H,
selecting the coupling strength coefficient of the primary operator O as u=π/4+a*π where a is an integer, for isolating a single M-body term,
wherein the primary operator O and auxiliary operator H are selected to anticommute, wherein the square of the primary operator O is equal to an identity matrix,
wherein the iterative decomposing comprises repeatedly selecting subsequent primary and auxiliary operators until final primary operators and final auxiliary operators that are tensor products of two Pauli matrices and thus correspond to two-qubit interactions are obtained, wherein the decomposing of a previously determined primary operator O comprises reselecting the central qubit before selecting subsequent primary and auxiliary operators, wherein the central qubit is selected from qubits of the operator that is being decomposed.

The primary operators at each decomposition step may comprise a tensor product of Pauli matrices acting on qubits on a first side of the central qubit in the considered multi-qubit operator and including a Pauli matrix acting on the central qubit, and the auxiliary operators at each decomposition step comprise a tensor product of Pauli matrices acting on qubits on a second side of the central qubit in the considered multi-qubit operator and including a Pauli matrix acting on the central qubit, wherein the Pauli matrix acting on the central qubit in the considered multi-qubit operator is of first type, and the Pauli matrix acting on the central qubit in the primary operator is selected to be of second type, and the Pauli acting on central qubit in the auxiliary operator is selected to be of third type.

The decomposition of at least one of the multi-qubit interaction terms may be carried out a plurality of times in a plurality of alternative decompositions, to obtain a plurality of alternative decomposed sequences of steps acting on qubits, wherein the method additionally comprises determining a plurality of alternative combined sequences of steps acting on qubits and determining a plurality of alternative compressed sequences of steps acting on qubits. The method may then comprise selecting as a compressed sequence of steps acting on qubits to be used in a subsequent joining procedure or as a compressed sequence of steps acting on qubits to be used as a final sequence of steps acting on qubits, a compressed sequence of steps acting on qubits providing a lowest circuit depth of the plurality of alternative compressed sequences of steps acting on qubits.

The alternative decompositions may be carried out by selecting a different qubit as a central qubit and/or selecting different type of Pauli matrix for the primary operator and auxiliary operator at at least one of the iterations in the alternative decompositions.

Using the decomposition as described above enables to remove the need for adding ancillary spins and may thus provide the best possible solution within the limitations.

The method may be used for determining a control sequence for simulating a Hamiltonian operator comprising a plurality of interaction terms corresponding to multi-qubit operators, wherein the plurality of qubit entities comprise at least multi-qubit operators corresponding to the interaction terms of the Hamiltonian operator.

The method may be used for determining a control sequence for simulating a fermionic Hamiltonian, the method further comprising
obtaining parameters of a fermionic Hamiltonian to be simulated, the parameters comprising at least:
   a number of fermionic lattice sites L,
   a number of fermionic modes m in the fermionic lattice, and
   fermionic operators corresponding to interactions between the fermionic modes m,
projecting the fermionic lattice to the qubit layout of the quantum device such that every fermionic mode is assigned to a qubit of the quantum device, wherein said qubit is referred to as a physical qubit P, wherein the projection between the fermionic modes and the physical qubits is one to one, and wherein a plurality of further qubits of the quantum device are referred to as ancilla qubits A, said ancilla qubits A not being assigned with any fermionic mode,
wherein the physical qubits P and the ancilla qubits A are arranged onto horizontal single lines of the two-dimensional square lattice, each horizontal single line comprising at least one string P′ and at least one ancilla qubit A, wherein each string P′ comprises one or more physical qubits P,
wherein the arrangement of physical qubits P and ancilla qubits A in each single horizontal line of the qubit layout is the same,
   associating each physical qubit P with at least one edge operator E and one vertex operator V, comprising:
associating each physical qubit P with a vertex operator Vₚ, wherein Vₚ is a Pauli operator of first type, selected from Pauli operator types X, Y and Z, acting on physical qubit p,
for any pair of physical qubits p and q, which in the horizontal dimension are either direct neighbors without any physical or ancilla qubits between them, or are separated by one or two ancilla qubits, define a horizontal edge operator E_{pq}^{H}, associated with said qubits, wherein E_{pq}^{H} is a product of a number of Pauli operators comprising:
   at least two Pauli operators, each of second or third type, selected from Pauli operator types X, Y, and Z, and acting on qubits p and q respectively, and
   if any ancilla qubits are present between the physical qubits p and q along the horizontal dimension, additional Pauli operators, each of first type, acting on each of said, if any present, ancilla qubits,
   wherein when two horizontal edge operators act on the same qubit q, if the first of the two horizontal edge operators E_{pq}^{H1} acts on the qubit q with a Pauli operator of second type, then the second of the two horizontal edge operators E_{pq}^{H2} acts on the qubit q with a Pauli operator of third type and vice versa,
for any pair of physical qubits p and q, where said physical qubits p and q are direct neighbors in the vertical dimension, and where said pair of physical qubits is adjacent to a pair of ancilla qubits a and b, where said ancilla qubits a and b are direct neighbors in the vertical dimension, said ancilla qubits a and b are arranged adjacent to the qubits p and q respectively, define a vertical edge operator E_{pq}^{V}, associated with said qubits p, q, a, b, wherein E_{pq}^{V} is a product of four Pauli operators, each of second or third type and each acting on one of the qubits p, q, a, b such that each of the four Pauli operators acts on a different qubit, wherein
   the Pauli operators acting on the ancilla qubits a and bare of different type,
   the Pauli operator acting on the physical qubit p is of the same type as the Pauli operator acting on the physical qubit q and forming a part of the horizontal edge operator acting on at least the physical qubit p and the ancilla qubit a, and similarly the Pauli operator acting on the physical qubit q is of the same type as the Pauli operator acting on the physical qubit q and forming a part of the horizontal edge operator acting at least on the physical qubit q and the ancilla qubit b,
   a vertical edge operator is referred to as a first vertical edge operator E_{pq}^{V1} when the ancilla qubits a and b are arranged on a first side of the physical qubits p and q respectively along the horizontal dimension, or as a second vertical edge operator E_{pq}^{V2} when the ancilla qubits a and b are arranged on a second side of the physical qubits p and q along the horizontal dimension,
wherein when two vertical edge operators act on the same ancilla qubit, if one of the two vertical edge operators acts on said ancilla qubit with a Pauli operator of second type, then the other of the two vertical edge operators acts on said ancilla qubit with a Pauli operator of third type and vice versa,
mapping each fermionic operator to a qubit operator based on the edge operators E and vertex operators V, wherein at least one of the determined qubit operators is utilized as a second qubit entity.

In an aspect of the invention, a computer program product according to independent claim 24 may be provided. In yet further aspects of the invention, a quantum circuit according to claim 25 and a method for determining at least one characteristic of a system according to claim 26 may be provided.

The novel features which are considered as characteristic of the invention are set forth in particular in the appended claims. The invention itself, however, both as to its construction and its method of operation, together with additional objects and advantages thereof, will be best understood from the following description of specific example embodiments when read in connection with the accompanying drawings.

### BRIEF DESCRIPTION OF THE DRAWINGS

Next the invention will be described in greater detail with reference to exemplary embodiments in accordance with the accompanying drawings.

FIG. 1 illustrates a flow chart according to one embodiment of the invention.

FIG. 2 shows a schematic decomposition according to one embodiment of the invention.

FIG. 3 illustrates a flow chart of at least a portion of a decomposition method according to one embodiment of the invention.

FIG. 4 illustrates a flow chart of a decomposition method according to one embodiment of the invention.

FIG. 5 depicts a quantum circuit that may be obtained as a result of a decomposition.

FIG. 6 shows a graphical notation which may be used in connection with the present invention, the figure showing the options of two-qubit operators that may be obtained through decomposition.

FIG. 7 shows possible decompositions of a three-qubit operator.

FIG. 8 shows possible decompositions of a four-qubit operator.

FIG. 9 shows possible decompositions of a five-qubit operator.

FIG. 10 depicts sequences of steps acting on qubits.

FIG. 11 shows sequences of steps acting on qubits where shifting, commutating, merging, and cancellation are illustrated.

FIG. 12 shows reconstruction in relation to a single-qubit operator and a two-qubit operator.

FIG. 13 shows commuting, cancelling, and merging of two-qubit operators.

FIG. 14 depicts combining of anti-commuting two-qubit operators into a single two-qubit operator.

FIG. 15 shows results of decomposition, combining, and compression of two multiqubit operators.

FIG. 16 illustrates results of decomposition, combining, and compression of four multiqubit operators.

FIG. 17 shows some examples of fermionic lattice geometries.

FIG. 18 illustrates some examples of vertex and edge operators.

FIG. 19 gives an example of a fermionic lattice and considered connectivity and interaction terms.

FIG. 20 illustrates a qubit hardware layout.

FIG. 21 depicts exemplary hopping operators.

FIG. 22 shows a quantum circuit.

FIG. 23 depicts an example of edge and vertex operators.

### DETAILED DESCRIPTION

The computer-implemented method of the present invention may at least partially be carried out by a first computing device, usually a classical computer, such that the method may additionally comprise providing the control sequence obtained through the method as a computer-readable output deliverable for implementing on a second computing device being a quantum device. The quantum device and the computing device that the method of the present invention is carried out on may be entirely separate devices or they may be coupled devices, wherein the control sequence may be directly deliverable to the quantum device or directly implementable thereon. The control sequence may comprise or correspond to a sequence of quantum gates.

The quantum device may comprise at least one quantum processor. The quantum processor may comprise a plurality of qubits or other quantum elements. In embodiments of the invention, the connectivity of e.g. qubits may be arbitrary.

In one embodiment, the plurality of quantum elements may be arranged in a square lattice layout. Each quantum element may be connectable/couplable with at most four neighboring other quantum elements on the square lattice. The quantum processor may also comprise a plurality of qubits that are arranged in a plurality of square lattice qubit layouts. The square lattice may comprise rows or lines of qubits arranged in two dimensions, e.g. a horizontal and vertical dimension.

In one embodiment, the method may comprise information indicative of native interactions or gates of the quantum device. This information may be used in the method to convert non-native SQGs and/or TQGs into native gates if necessary. The information characterizing the native gates of the quantum device (or second computing device) may be, e.g., obtained as an input or may be known.

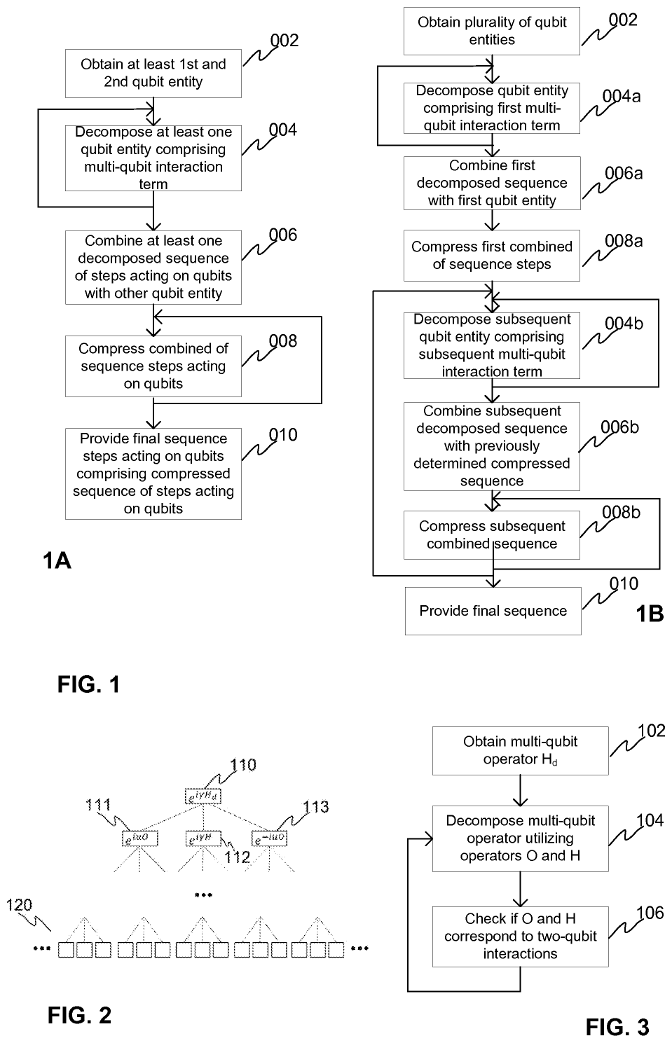

With reference to FIG. 1A, a method may comprise obtaining 002 at least a first qubit entity and a second qubit entity, wherein a qubit entity comprises a sequence of steps acting on qubits. A first qubit entity may comprise a first sequence of steps acting on qubits. The second qubit entity may comprise a single multi-qubit interaction term.

A multi-qubit interaction term (also called operator) involves M qubits and is expressible as a tensor product of Pauli matrices and identifies the qubits to be involved and the types of corresponding Pauli matrices.

According to the first embodiment of the invention, at least the second qubit entity is decomposed 004 to determine a decomposed sequence of steps acting on qubits, where the decomposition is carried out with the method described herein later on. The decomposition may comprise iterative decomposition of a multi-qubit interaction term.

The decomposed sequence of steps acting on qubits of the second qubit entity is then combined 006 with another qubit entity, which in the first step of combining is the first qubit entity, or the first sequence of steps acting on qubits. A combined sequence of steps acting on qubits is thus determined.

The combined sequence of steps acting on qubits is then compressed 008 to determine a compressed sequence of steps acting on qubits. The compression may comprise iterative or recursive steps of compression, with one step of compression comprising one action of compression or a combination of simultaneous actions, said actions being commuting through, cancelling, shifting, reconstructing or merging into a single two-qubit operator. A subsequent step of compression may comprise one or more compression actions, which may be of the same type or different than in a previous step. The compression may be a combination of any of the different type of actions cited above, and any type of action can be repeated until the compressed sequence is no more compressible, meaning the different type of action do not have any effect anymore on the interaction terms in the sequence of step of the compressed sequence, and the depth of the compressed sequence can not be reduced anymore.

The decomposing may be carried out separately for any of the obtained qubit entities that comprise multi-qubit operators.

Combining with another qubit entity may comprise combining the decomposed sequence of steps acting on qubits of the second qubit entity with a compressed sequence of steps acting on qubits that has been determined as a result of a previously performed procedure of decomposing, combining and compressing, to obtain at least one further or subsequent combined sequence of steps acting on qubits. The further or subsequent combined sequence of steps acting on qubits may then be again compressed to determine a further or subsequent compressed sequence of steps acting on qubits.

When it is determined that a considered plurality of qubit entities does not comprise any further multi-qubit operators, the compressed sequence of steps acting on qubits that has been determined in a previous step of compressing may be provided 010 as a final sequence of steps acting on qubits.

A first joining procedure performed in a method may be carried out with a first sequence of steps acting on qubits comprising a series of single and/or two-qubit operators and a second qubit entity being a single multi-qubit operator. Here, it may be only the at least second qubit entity (or second and any further qubit entities) that is received as an input, e.g. from a user, while the method comprises obtaining or generating the first qubit entity for the first joining procedure, e.g. in the case that only single multi-qubit operators are obtained as qubit entities.

FIG. 1B shows one further embodiment of a method, where a plurality of qubit entities are obtained 002, comprising at least a first qubit entity and a second qubit entity, where the second qubit entity comprises a single multi-qubit interaction term. The obtained qubit entities comprise also at least a subsequent qubit entity that comprises a subsequent multi-qubit interaction term.

The steps of 004a, 006a, and 008a may essentially correspond to those carried out in the embodiment of FIG. 1A. After obtaining a first combined sequence of steps acting on qubits at 008a, a subsequent qubit entity may be (iteratively) decomposed at 004b to determine a subsequent decomposed sequence of steps acting on qubits. At 006b, the subsequent decomposed sequence of steps acting on qubits may be combined with the compressed sequence of steps that was determined as the first compressed sequence of steps at 008a (or a compressed sequence of steps that has been obtained at a previously carried out compression step) to determine a subsequent combined sequence of steps.

At 008b, the determined subsequent combined sequence of steps acting on qubits is compressed to determine a subsequent compressed sequence of steps.

Regarding each further or subsequent qubit entity that is a multi-qubit interaction term, the decomposing, combining, and compressing may be repeated. A final sequence of steps acting on qubit may be determined 010 as the last determined compressed sequence of steps acting on qubits.

In what follows, the decomposition shall be disclosed first in more detail, in which decomposition of a multi-qubit operator H_{d} (which may refer to a qubit entity, if the qubit entity is a multi-qubit operator) into two-qubit operators or two-qubit interactions will be discussed. The result of a decomposition may be the determined two-qubit operators. The determined two-qubit operators may be further manipulated to provide, as a result, a circuit or control sequence or series of steps acting on qubits that comprises only single-qubit and/or two-qubit operators that may correspond to native interactions of a quantum device.

Relating to the many-body problem, one of the considered challenges in quantum computing has been in optimally implementing a multi-qubit operator H_{d}, such as a many-body Hamiltonian operator, which contains a string of Pauli terms acting on a number of different qubits, where the Hamiltonian describes the behavior of a many-body system and a quantum computation aims at implementing the dynamics generated by the Hamiltonian. The unitary that is to be implemented is of the form unitary U=e^{iγH}^{_{d}} (γ being the coupling strength constant of the Hamiltonian H_{d}). The decomposition presented herein proposes a method to obtain and implement a single isolated Pauli string term. A string of Pauli terms could be, for example, σ_{z}⁰σ_{y}¹σ_{y}²σ_{y}³σ_{y}⁴σ_{z}⁵, where σ_{z}⁰ is a Z-type Pauli matrix acting on qubit 0, σ_{y}¹ is a Y-type Pauli matrix acting on qubit 1 and so on. Pauli matrices can be of X, Y, or Z types. It may be noted that the decomposition and compression techniques presented herein may also be related to other types of multi-qubit operators, not necessarily Hamiltonian operators, that are to be implemented on a quantum device, where the multi-qubit operators comprise a similar form, i.e. involving unitaries of e^{iγH}^{_{d}}, where H_{d} comprises a tensor product of Pauli matrices. The method may enable more efficient running of quantum algorithms involving such operators (i.e. less operational steps through reduced circuit depth).

A non-commutative unitary transformation may be performed, where H_{d}=e^{iO}He^{-iO}, where O is a primary operator and H is an auxiliary operator, such that the primary operator and the auxiliary operator do not commute and contain a string of Pauli interactions. The primary operator O and auxiliary operator H may anticommute.

The task at hand is to appropriately find a scheme to obtain the terms of H and O and decompose them into TQGs, such that preferably the number of TQGs and/or the depth of the circuit is optimal. The identities given below for matrices P and R may be utilized, where equation (1) is the Baker-Campbell-Hausdorff expansion and where the second identity (equation (2)) is derived due to the fact that P is invertible which leads to the third identity (equation (3)) iff P⁻¹=−P:

$${e}^{P} R {e}^{- P} = R + [ P , R ] + \frac{1}{2 !} [ P , [ P , R ] ] + \frac{1}{3 !} [ P , [ P [ P , R ] ] ] + … \qquad ( 1 )$$

$${e}^{{PRP}^{- 1}} = P {e}^{R} {P}^{- 1} \qquad ( 2 )$$

$${e}^{P} {e}^{R} {e}^{- P} = {e}^{R + [ P , R ] + \frac{1}{2 !} [ P , [ P , R ] ] + …} . \qquad ( 3 )$$

Giving e^{iγH}^{_{d}} in terms of coupling strength constant u for the primary operator O:

$${e}^{i γ {H}_{d}} = {e}^{i u O} {e}^{i γ H} {e}^{- i u O} = {e}^{i γ ( cos ( 2 u ) H + \frac{i}{2} sin ( 2 u ) [ O , H ] + O \{ O , H \} s i {n}^{2} u )} . \qquad ( 4 )$$

Combining the above equations with a selection of the coupling strength constant u=π/4+a*π, equation (4) reduces to a much simpler and easier to handle as well as to implement form of

$${e}^{i γ ( \frac{i}{2} [ O , H ] + \frac{1}{2} O \{ O , H \} )} .$$

If the primary operator O and auxiliary operator H further anti-commute, then equation (4) further simplifies to

$${e}^{- \frac{1}{2} γ [ O , H ]} .$$

With the above,

$$U = {e}^{i γ {H}_{d}} = {e}^{i \frac{π}{4} O} {e}^{i γ H} {e}^{- i \frac{π}{4} O} = {e}^{i γ ( H + \frac{i π}{4} [ O , H ] + \frac{{i}^{2} {π}^{2}}{2 ! {4}^{2}} [ O , [ O , H ] ] … )} , \qquad ( 5 )$$

where the coupling strength of O has cleverly been set to

$$\frac{π}{4} .$$

Using [O, H]≠0 and {O, H}=0 with O, H Hermitian operators and that O² and H² shall equal identity:

$${e}^{i α O} = cos ( α ) I + i sin ( α ) O . \qquad ( 6 )$$

Combining the properties above:

$$U = {e}^{i γ {H}_{d}} = {e}^{\frac{i γ}{2} ( I + iO ) H ( I - iO )} \qquad ( 7 )$$

$$= {e}^{\frac{i γ}{2} ( O \{ O , H \} + i [ O , H ] )} . \qquad ( 8 )$$

This gives

$${H}_{d} = \frac{i}{2} [ O , H ] .$$

Using the above, a sequence of terms can be generated and setting the coupling strength of the primary operator O appropriately, an isolated many-body term can be generated. This term could then also be rotated individually to get the required combination of Pauli matrix type X, Y and Z operations of the many-body term. Such a protocol can be implemented on the quantum computer, without any ancillary spins, using a digital algorithm where the unitary transformations are represented by gates.

In some embodiments, after decomposition, a first and/or second control sequence of interactions can be expressed as H_{d}=e^{iO}′H′e^{-iO}′, where H′ is a central final auxiliary operator H, and O′ is a sum of all the final primary and auxiliary operators O and H except for the central final auxiliary operator and where H′ and O′ do not commute and any summand of the O′ commutes with any other summand of O′.

As illustrated schematically in FIG. 2, the method may involve decomposing a multi-qubit interaction term 110 into a sequence of three interaction terms 111, 112, 113. A first interaction term 111 is described by a unitary e^{iuO} of a primary operator O where u is a coupling strength coefficient of O between the qubits on which the primary operator O acts. A second interaction term 112 is described by a unitary e^{iγH} of an auxiliary operator H, while a third interaction term 113 is described by a unitary e^{-iuO} of the negative of the primary operator −O, and H and O are each a tensor product of at least two Pauli matrices. The first 111, second 112 and third 113 interaction terms produced by the decomposition 104 involve fewer qubits than the original multi-qubit interaction term 110.

A desired multi-qubit operator H_{d} involving M qubits may be known or determined. The multi-qubit operator H_{d} may be expressible as a tensor product of M Pauli matrices and identifies the qubits to be involved and types of corresponding Pauli matrices. The multi-qubit operator H_{d} may refer a qubit entity. E.g. at least one of the received or obtained qubit entities may be a multi-qubit operator H_{d} that is decomposed. Any number of qubit entities obtained may be multi-qubit entities H_{d} that are decomposed.

Referring to FIG. 3 and regarding one embodiment of the present invention, the multi-qubit operator H_{d} may be obtained 102 e.g., as an input by the first computing device comprising at least one processor that is utilized to carry out the method for determining a control sequence. H_{d} may be known or determined based on a problem to be solved involving a system comprising M bodies, where a certain characteristic of the system is to be determined. A multi-qubit operator H_{d} may be a Hamiltonian operator or it may e.g. be one term of a Hamiltonian operator. Considering a Hamiltonian operator with a plurality of terms, each term that is a multi-qubit operator may be considered as a multi-qubit operator H_{d} that is received in the method, and the decomposing may be carried out separately for each such term. The terms may thereafter be combined and advantageously compressed, to provide a final quantum circuit to be implemented, which will be described further below.

Any of the input(s) considered may be obtained by the first computing device, and they may, e.g., be provided by a user of the first computing device or by another computing program determining the input(s) based on additional information provided by the user, where the additional information could be, e.g., properties describing the quantum device on which a specific series of qubit interactions is to be implemented and/or desired properties of e.g. a Hamiltonian that is to be simulated via the series of qubit interactions. At least some of the methods considered herein may be carried out without all the possible information considered here as possible inputs being provided.

The term “qubit number” may refer to a number that is used to identify specific qubits comprised in a specific quantum device. Of course, other identifiers could also be used instead of numbers.

The decomposing may comprise iterative decomposition of interaction terms involving primary operators and auxiliary operators until a first and/or second multi-qubit interaction term 110 has been decomposed into a sequence of two-qubit interaction terms 120, each interaction term being described by an operator comprising a tensor product of two Pauli matrices. In the decomposed sequence, any two-qubit interaction terms corresponding to non-native interactions may be converted into combinations of single-qubit interaction terms and two-qubit interaction terms.

The multi-qubit interaction term 110 of the first decomposition step 104 may be described by a unitary e^{iγH}^{_{d}} of the many-body operator H_{d}, where γ is a coupling strength coefficient of H_{d}, and the multi-qubit interaction term 110 in the subsequent decomposition step(s) may be related to a primary operator O or an auxiliary operator H if said operators are not two-qubit interaction terms (i.e., if they act on more than two qubits).

The operators comprising a tensor product of two Pauli matrices may be one of σₓⁱσₓ^{j}, σ_{y}ⁱσ_{y}^{j}, σ_{z}ⁱσ_{z}^{j}, σₓⁱσ_{y}^{j}, σₓⁱσ_{z}^{j}, σ_{y}ⁱσ_{z}^{j}, where i≠j are qubit numbers and X, Y, Z refer to Pauli matrix type. In a particular embodiment, the operators comprising a tensor product of two Pauli matrices can correspond to Ising Coupling gates, corresponding to the σₓⁱσₓ^{j}, σ_{y}ⁱσ_{y}^{j}, σ_{z}ⁱσ_{z}^{j} operators. It is worth noting that Ising Coupling gates are natively implementable in some trapped-ion quantum computers.

At step 104 of FIG. 3, the many-body operator H_{d} is taken in a first decomposition step, where the corresponding multi-qubit interaction is decomposed utilizing at least a first primary operator O and a first auxiliary operator H.

In some embodiments, the method may comprise a checking step 106 to check if the previously obtained primary operator O and auxiliary operator H correspond to two-qubit interactions. If not, the method may comprise repeating at least the steps 104 and 106 with the one or more primary operator(s) O and/or auxiliary operator(s) H last obtained, which is/are not corresponding to two-qubit interactions, until primary operators O and auxiliary operators H comprise only one- or two-qubit interaction terms 120.

Thus, the decomposing may comprise decomposing a multi-qubit interaction term 110 described by a unitary e^{iγH}^{_{d}} of the multi-qubit or many-body operator H_{d}, into a sequence of three interaction terms, a first interaction term 111 described by a unitary e^{iuO} of a primary operator O where u is a coupling strength coefficient of O between the qubits on which the primary operator O acts, a second interaction term 112 described by a unitary e^{iγH} of an auxiliary operator H, and a third interaction term 113 described by a unitary e^{-iuO} of the negative of the primary operator −O, wherein H and O are each a tensor product of at least one Pauli matrix, involving M_{H} and M_{O} qubits, respectively.

If M_{O}>2, the decomposing may be repeated on the first interaction term 111, decomposing it into a sequence of three subsequent interaction terms, each involving less than M_{O} qubits. The decomposing may then also comprise repeating the decomposing on the third interaction term 113 or obtaining a repeatedly decomposed third interaction term 113 by changing the signs of the outcome of repeating the decomposing on the first interaction term 111.

If M_{H}>2, the decomposing may be repeated on the second interaction term 112, decomposing it into a sequence of three subsequent interaction terms, each involving less than M_{H} qubits.

The decomposing of the resulting terms may be iterated until the multi-qubit interaction e^{iγH} has been decomposed into a series of at least three one- or two-qubit interaction terms 120.

FIG. 2 shows schematically how the method may be used to decompose the interaction terms 110, 111, 112, 113, finally arriving at two-qubit interactions 120. The rectangular boxes in FIG. 2 illustrate gates, unitary transformations or interaction terms. The lines in FIG. 2 indicate that each interaction term, which comprises interaction between more than two qubits, is decomposed into three further interaction terms, which can then be further decomposed into subsequent three interaction terms and so on until all interaction terms are decomposed into one- or two-qubit interaction terms. The top row in FIG. 2 thus shows the multi-qubit interaction term 110 that is to be decomposed, whereas the bottom row in FIG. 2 shows the resulting control sequence comprising a plurality of two qubit interaction terms or TQGs 120.

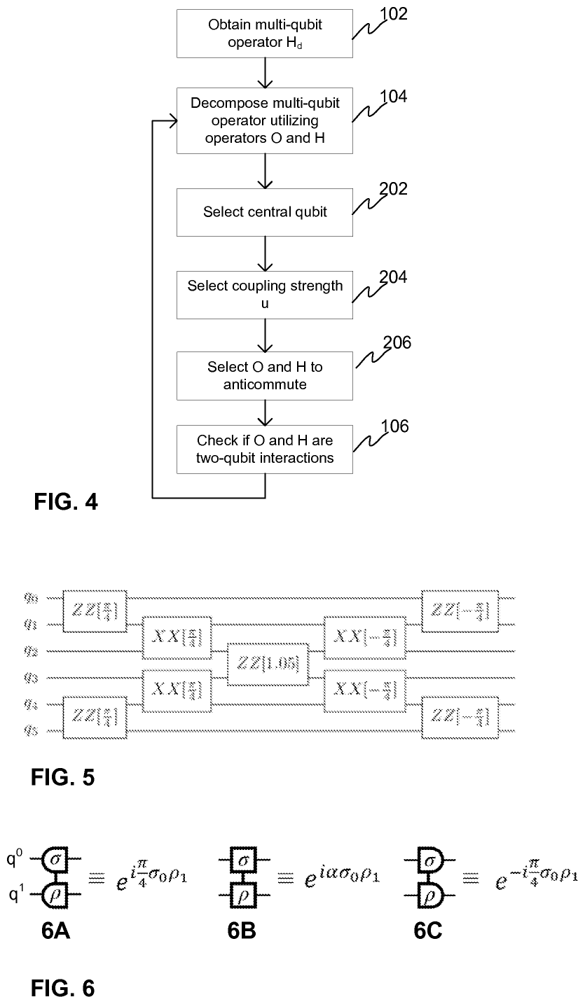

In some embodiments and referring to FIG. 4, the method may comprise firstly selecting 202 at least one of the identified qubits in the multi-qubit operator H_{d} as a central qubit. The central qubit may be considered as the qubit at which the multi-qubit operator that is being decomposed is split into the primary and auxiliary operators, where the central qubit is involved in both the primary and auxiliary operator.

The central qubit may thus be selected in a number of different ways if the multi-qubit operator H_{d} involves over three qubits. The choice of central qubit at each decomposition step in the iterative decomposing may affect the “shape” of resulting quantum circuit. Thus, the selection of central qubit may give a plurality of different decompositions that may be carried out involving the same multi-qubit operator H_{d}.

A first auxiliary operator H may be selected as a tensor product of M_{H} Pauli matrices, where each Pauli matrix in the tensor product acts on a different qubit, said qubits selected from those specified by the multi-qubit operator H_{d} and the selection including the at least one central qubit, and where M_{H} is less than the number of Pauli matrices of the multi-qubit interaction being decomposed.

A first primary operator O may be selected as a tensor product of M_{O} Pauli matrices, where M_{O} is less than the number of Pauli matrices of the multi-qubit interaction being decomposed and where each Pauli matrix in the tensor product acts on a different qubit, the qubits and Pauli matrices of the first primary operator O selected such that at least one qubit is one of the least one central qubits and H_{d} is proportional to the commutator of the primary operator O and the auxiliary operator H.

Furthermore, the coupling strength coefficient of the primary operator O may be selected 204 as u=π/4+a*π, and the primary operator O and auxiliary operator H may be selected 206 to anti-commute. The steps 204 and/or 206 may also be carried out in a different order.

The iterative decomposing may then comprise repeatedly selecting subsequent primary and auxiliary operators until the final primary operator and final auxiliary operators are tensor products of two Pauli matrices and thus correspond to two-qubit interactions.

Here, the selection 202 of central qubit(s) may occur each time the decomposition is carried out. The decomposing of a previously determined primary operator O or auxiliary operator H may comprise reselecting the central qubit(s) before selecting subsequent primary and auxiliary operators, wherein the central qubit is now selected from qubits of the operator that is being decomposed.

The primary operators at each decomposition step comprise a tensor product of Pauli matrices acting on qubits on a first side, such as left-hand side or right-hand side, of the central qubit in the considered multi-qubit interaction term and include a Pauli matrix acting on the central qubit, and the auxiliary operators at each decomposition step comprise a tensor product of Pauli matrices acting on qubits on a second side of the central qubit in the considered multi-qubit interaction term and include a Pauli matrix acting on the central qubit.

The Pauli matrix acting on the central qubit in the considered multi-qubit interaction may be considered to be of first type, whereby the Pauli matrix acting on the central qubit in the primary operator is selected to be of second type, and the Pauli acting on central qubit in the auxiliary operator is selected to be of third type.

Therefore, at each decomposition step, there are two different possibilities for the selection of the Pauli matrix types acting on central qubits in the primary and auxiliary operators. There may thus be a number of alternative ways in which the decomposition may be carried out also in this regard, in addition to the selection of central qubit.

Alternative decompositions (or decomposition paths) may give rise to a plurality of different “shapes” of circuits, such as V-shapes or X-shapes.

Decomposing may be carried out separately for each of the qubit entities that are single multi-qubit operators. The result of the decomposition may be a decomposed sequence of steps acting on qubits, which may be a sequence of single- and/or two-qubit operators. The iterative decomposition will lead to a sequence of two-qubit operators, but two-qubit operators corresponding to non-native gates of a given quantum device may be converted to native operations using single-qubit rotations.

An example of decomposition involving a second qubit entity that is a multi-qubit operator and a first qubit entity that is an empty circuit will be given next. A multi-qubit operator H_{d} of σ_{z}⁰σ_{y}¹σ_{y}²σ_{y}³σ_{y}⁴σ_{z}⁵ considering six bodies and involving 6 qubits may be obtained or known (with H_{d} here being merely exemplary). Qubit numbering is started at 0 in this example.

In a first step, a central qubit identified here as qubit numbered 2 may then be selected.

A second step may then comprise decomposing, comprising determining a first primary operator O=σ_{z}⁰σ_{y}¹σₓ² and first auxiliary operator H=−σ_{z}²σ_{y}³σ_{y}⁴σ_{z}⁵ to obtain

$${U}_{D} = {e}^{i γ {H}_{d}} = {e}^{i \frac{π}{4} O} {e}^{i γ H} {e}^{- i \frac{π}{4} O} and {H}_{D} = \frac{i}{2} [ O , H ] .$$

As seen, the obtained primary operator O and auxiliary operator H are not two-qubit interactions. The decomposing may then be carried out iteratively. In a third step of the method decomposing is repeated, and the first auxiliary operator H may be used as the new multi-qubit interaction to be decomposed, where

$${e}^{i γ H} = {e}^{i \frac{π}{4} {O}_{n}} {e}^{i γ {H}_{n}} {e}^{- i \frac{π}{4} {O}_{n}} and {H}_{D} = \frac{i}{2} [ {O}_{n} , {H}_{n} ] ,$$

with qubit numbered 3 being selected as a central qubit, and then with selected second primary operator as Oₙ=σₓ³σ_{y}⁴σ_{z}⁵ and selected second auxiliary operator as Hₙ=σ_{z}²σ_{z}³.

In a fourth step of the method, the first primary operator O and second primary operator Oₙ, which are three-body terms, may be further decomposed as

$${e}^{i γ O} = {e}^{i \frac{π}{4} {O}_{p}} {e}^{i γ {H}_{p}} {e}^{- i \frac{π}{4} {O}_{p}} , O = \frac{i}{2} [ {O}_{p} , {H}_{p} ] , {e}^{i γ {O}_{n}} = {e}^{i \frac{π}{4} {O}_{r}} {e}^{i γ {H}_{r}} {e}^{- i \frac{π}{4} {O}_{r}} , {O}_{n} = \frac{i}{2} [ {O}_{r} , {H}_{r} ] ,$$

with selected third primary operator Oₚ=σ_{z}⁰σ_{z}¹, third auxiliary operator Hₚ=σₓ¹σₓ², fourth primary operator Oᵣ=σ_{z}⁴σ_{z}⁵, and fourth auxiliary operator Hᵣ=σₓ³σₓ⁴.

The multi-qubit interaction H_{d} has then been decomposed into primary operators O and auxiliary operators H that are two-qubit interactions.

The obtained term may be compared with the initial desired multi-qubit operator term H_{d}. In this example, these are equivalent and no further SQGs are required. However, if this were not the case, then one layer may be applied before and after the applied interactions, to obtain the correct Pauli operators. Moreover, further SQGs can be applied to convert any non-native TQGs into native ones. Gates of XX and ZZ are considered to be native in this example, and no SQGs are needed.

After the above decomposition, the obtained decomposed sequence of steps or series or steps acting on qubits is combined with a first qubit entity to obtain a combined sequence of steps acting on qubits. The combined sequence of steps is compressed to obtain a compressed sequence of steps.

FIG. 5 shows a parallelized quantum circuit that may be determined for the above considered example, where the number of TQGs and/or circuit depth is optimized. Adjacent gates with opposite signs and acting on the same qubits are cancelled, and commutation relations can be used when needed when reducing the number of TQGs and/or circuit depth. Since in the current example XX- and ZZ-type gates are considered to be native, no further SQGs are needed. However, if any of the gates were not native, further SQGs could be applied to convert the non-native gates into native ones.

FIG. 6 shows at 6A-6C a graphical notation which can be used to depict gates in quantum circuits, here considering a first qubit q₀ and second qubit q₁. The figure shows the three different types of two-qubit gates (or operators) occurring in the decompositions, which depend on the prefactor in the exponential. Here, σ and ρ are Pauli operators acting on qubits q₀ and q₁, respectively. FIG. 6A shows how an operator corresponding to

$${e}^{i \frac{π}{4} {σ}_{0} {ρ}_{1}}$$

may be depicted in a quantum circuit. FIG. 6B shows how an operator corresponding to e^{iασ}^{₀}^{ρ}^{₁} may be depicted in a quantum circuit, where α is coupling strength (which may herein also be denoted by γ). FIG. 6C shows how an operator corresponding to

$${e}^{- i \frac{π}{4} {σ}_{0} {ρ}_{1}}$$

may be depicted in a quantum circuit. This graphical notation will be used in at least a portion of the figures that follow. It should be noted that not all figures show the qubit numbering.

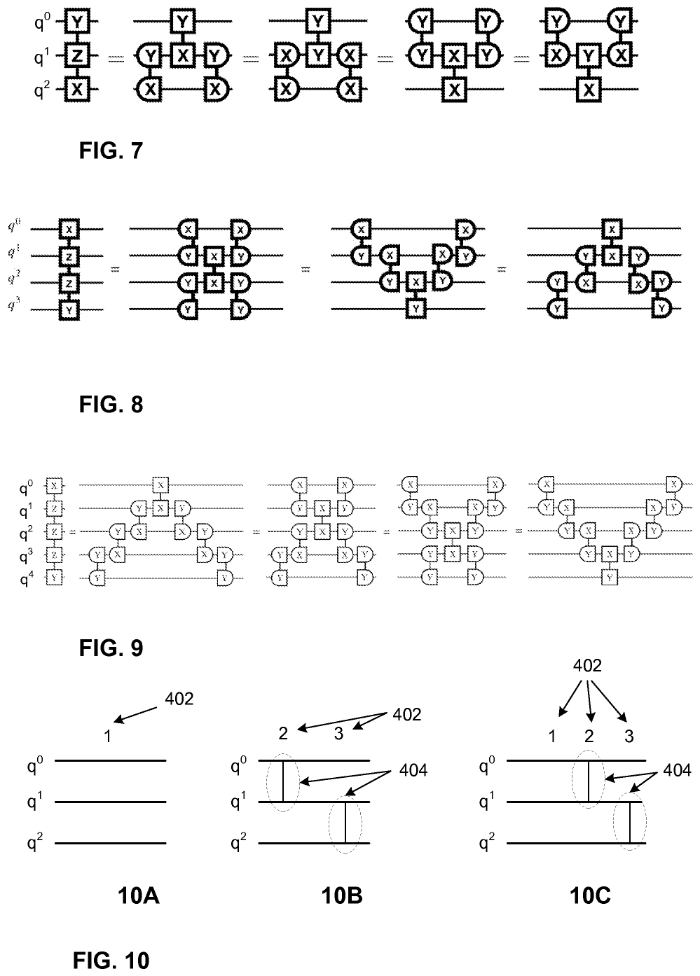

FIG. 7 illustrates all possible alternative decompositions of a multi-qubit operator H_{d}=σ_{y}¹σ_{z}²σₓ³ involving three qubits (with qubit numbering starting at 1). For a multi-qubit operator involving three qubits, there will only be one choice of centra qubit, but the selection of the Pauli matrices are selected at the different decomposition steps still gives a four different options for how to decompose the operator. The prefactors in the exponentials acting on the central qubits may differ in their sign.

Starting at a multi-qubit operator involving four qubits, the choice of how to select the Pauli matrices for primary and auxiliary operators at each decomposition step will lead to more alternative decompositions. The alternative decompositions will lead to X-shaped circuits and V-shaped circuits. FIG. 8 illustrates possible decompositions of a multi-qubit operator H_{d}=σₓ¹σ_{z}²σ_{z}³σ_{y}⁴ involving four qubits, while FIG. 9 shows possible decompositions involving five qubits and multi-qubit operator of H_{d}=σₓ¹σ_{z}²σ_{z}³σ_{z}⁴σ_{y}⁵.

If the obtained qubit entities comprise more than one single multi-qubit operator, the previous description of the second qubit entity being decomposed into a decomposed sequence of steps acting on qubits which is combined with the first qubit entity may first be carried out to determine a combined sequence of steps acting on qubits, which is finally compressed (if applicable, the compression may also comprise no steps if no compression steps are feasible) to determine a compressed sequence of steps acting on qubits.

A further multi-qubit operator, for example a second multi-qubit operator, may then also be decomposed into a sequence of steps acting on qubits comprising single- and/or two-qubit operators. The compressed sequence of steps acting on qubits obtained from the decomposing, combining, and compression involving a first qubit entity and second qubit entity may then be used such that the compressed sequence of steps acting on qubits is combined with the decomposed sequence of steps acting on qubits obtained from the decomposition of the further (such as second) multi-qubit operator to obtain a further combined sequence of steps acting on qubits. The further combined sequence of steps acting on qubits may once more be compressed to obtain a further compressed sequence of steps acting on qubits.

Regarding any further multi-qubit operator, a compressed sequence of steps acting on qubits that has been obtained in connection with a previously decomposed multi-qubit operator may be used as a first qubit entity, or one with which the multi-qubit operator now being decomposed is combined and compressed with.

FIGS. 10A-10C illustrate schematically sequences of steps acting on qubits. In this illustration, three qubits are shown, namely q₀, q₁ and q₂.

FIG. 10A shows a sequence of steps comprising step 1 with reference number 402, wherein the sequence of steps comprises only one step acting on qubits. The step 1 comprises no interactions between qubits. Such a sequence of steps comprising no interactions between qubits corresponds to an empty circuit and may be a first qubit entity. FIG. 10B shows a sequence of steps acting on qubits that comprises two steps 2 and 3 with reference number 402 and two two-qubit interactions 404 between qubits. FIG. 10C shows the result of a combination of the sequences of steps acting on qubits (or circuits) of FIGS. 10A and 10B. The combination then comprises a first step (in time) acting on qubits that does not comprise any qubit interactions, a second step acting on qubits that comprises one (first) two-qubit interaction, and a third step acting on qubits that comprises one (second) two-qubit interaction.

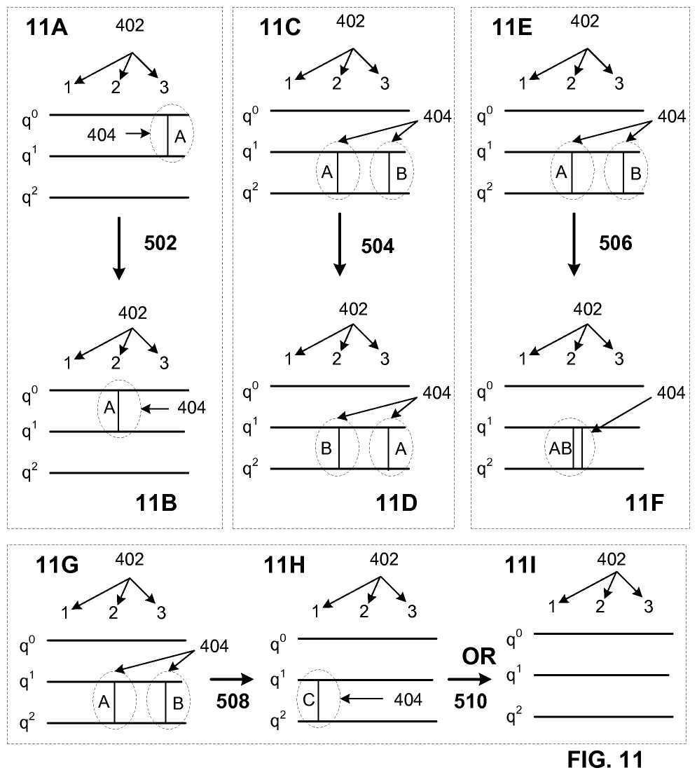

FIGS. 11A-11I schematically illustrate the different techniques of compression, such as shifting, commuting through, canceling, reconstruction, and merging into a single two-qubit operator/interaction, which can be used. These techniques may be performed on a combined sequence of steps acting on qubits obtained from the previous decomposition and combination steps. The compression can comprise at least one of the above techniques cited, namely it can comprise either one of shifting, commuting through, reconstructing, canceling, and merging into a single two-qubit operator/interaction, or any combination of the above. One or more of these actions/techniques may yield a compressed sequence of steps acting on qubits.

FIGS. 11A-11B shows one two-qubit interaction 404 of type A that is shifted 502 in the sequence of steps 402 acting on qubits from a third step to a second step. Regarding further example scenarios of shifting, for instance with four qubits and two steps, at step 1 a TQG may be acting on qubits 1 and 2, at step 2 a TQG may acting on qubits 3 and 4. The second TQG may then be shifted to step 1 and as a result, at step 2 no qubits are acted upon and the step can be removed. Thus one step of depth may be removed. It should be noted that any step where no action on qubits is present may be removed.

FIG. 11C shows a sequence of steps acting on qubits comprising a two-qubit interaction 404 of type A at step two and a two-qubit interaction of type B at step three, where the interactions act on the same qubits. After a commuting operation 504, as shown in FIG. 11D, only possible if the two gates commute, the two-qubit interaction of type B is carried out at step two, while the two-qubit interaction of type A is carried out at step three.

FIG. 11E shows a sequence of steps acting on qubits comprising a two-qubit interaction 404 of type A at step two and a two-qubit interaction of type B at step three, where the interactions act on the same qubits. After a merging operation 506, a sequence of steps acting on qubits of FIG. 11F comprises a two-qubit interaction of type AB carried out at step two.

FIG. 11G shows a sequence of steps acting on qubits comprising a two-qubit interaction 404 of type A at step two and a two-qubit interaction of type B at step 3, where the interactions act on the same qubits. After a reducing/cancellation operation 508, a sequence of steps acting on qubits of FIG. 11H comprises a two-qubit interaction of type C carried out at step one. Alternatively, after a cancellation operation 510, a sequence of steps acting on qubits of FIG. 11I comprises no interactions between qubits.

Regarding compression, it is enough to focus on operations between consecutive two-qubit gates, because all single-qubit gates appearing in between can be reconstructed through to the side. It may also be noted that non-neighboring gates may be made neighboring gates by e.g. applying one or more shifting operations. Considering an arbitrary two qubit gate of the form e^{-iασ}^{₁}^{^{a}}^{ρ}^{₂} and a single qubit gate of the form

$${e}^{\pm i \frac{π}{4} {σ}^{b}}$$

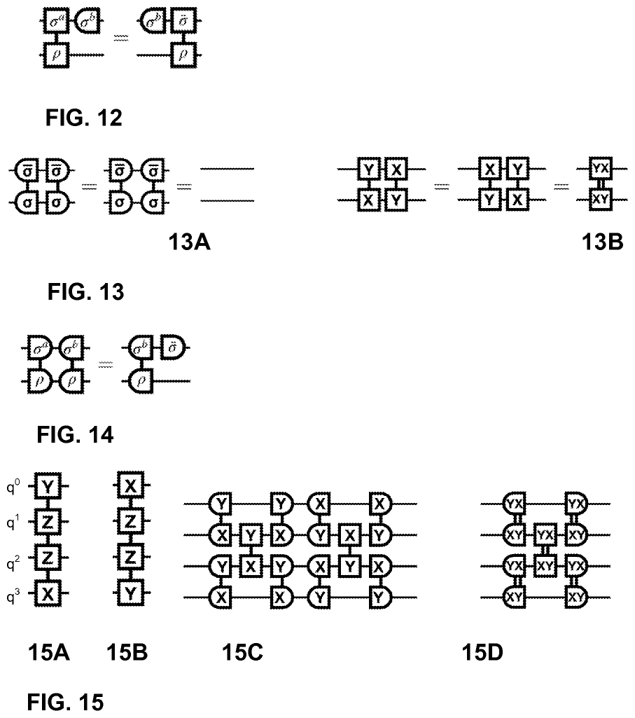

the identity of FIG. 12 will apply. Here,

$$σ = \pm {ε}_{abc} {σ}^{c}$$

and ε_{abc} is the Levi-Civita symbol. This will apply for any single qubit gate with a prefactor

$$\pm \frac{π}{4}$$

but of course, in the negative case, the appropriate signs shall be reversed. If there is an arbitrary prefactor α, the reconstruction of FIG. 12 will, however, not apply.

The acts that may be carried out in compression will be explained next in more detail. Given a commuting pair of gates acting on the same qubits they can be either commuted through, shifted, reconstructed, cancelled if they differ only by the sign prefactor in the exponential or merged into a single gate if this gate is considered native. Thus, e.g. a first qubit entity and second qubit entity may comprise steps or interactions acting at least on a subset of same qubits. Graphically the operations may be shown as in FIG. 13, where 13A depicts two-qubit gates acting on the same qubits that are commuted through and cancelled and FIG. 13B shows two-qubit gates acting on the same qubits that are merged into a single two-qubit gate. In FIG. 13B, the two last gates have been grouped into e^{-iα(X}^{₁}^{Y}^{₂}^{+Y}^{₁}^{X}^{₂}⁾, which up to single qubit rotations corresponds to a parametrized iSWAP gate

$$( ≡ {e}^{- i \frac{π}{4} ( {X}_{1} {Y}_{2} + {Y}_{1} {X}_{2} )} ) .$$

Any combination of two gates shown in FIGS. 6A-6C with the same prefactor in the exponential can be implemented using a single two-qubit gate and single qubit rotations given a set of three native gates, i.e. the set of {e^{-iϕZ}^{₁}^{Z}^{₂}, e^{iϕ(X}^{₁}^{Y}^{₂}^{+Y}^{₁}^{X}^{₂}⁾, e^{ϕ(X}^{₁}^{Y}^{₂}^{+Z}^{₁}^{Z}^{₂}⁾}. More generally, all such gates can be implemented, up to single qubit rotations, as a fermionic simulation (fSIM) gate

$${fSIM}_{ij} ( θ , ϕ ) = {e}^{i \frac{θ}{2} ( {X}_{i} {X}_{j} + {Y}_{i} {Y}_{j} ) + i \frac{θ}{4} ( {Z}_{i} {Z}_{j} + {Z}_{i} {Z}_{j} )} .$$

The fSIM gate has been natively implemented on existing superconducting platforms and has been shown to be efficient in the context of the Jordan-Wigner fermion-to-qubit mapping combined with a fermionic swap (fSWAP) gate network.

For anti-commuting two-qubit gates acting on the same qubits it is possible to combine them into a single two-qubit gate if they have a ±π/4 prefactor in the exponential, which is the common case. This is graphically shown in FIG. 14, where

$${σ}^{a} = \frac{i}{2} [ {σ}^{b} , \overline{σ} ] .$$

It is also possible to commute through two-qubit gates which are overlapping on a single qubit if they are acting on it with the same Pauli operator.

In the following, some examples are given on how the decomposition, combining, and compression techniques comprising commuting through, cancelling, shifting, and/or merging may be used in practice.

FIG. 15 shows at 15A and 15B two multiqubit operators, a first multi-qubit operator H_{d,1}=σ_{y}⁰σ_{z}¹σ_{z}²σₓ³ (15A) and a second multi-qubit operator H_{d,2}=σₓ⁰σ_{z}¹σ_{z}²σ_{y}³ (15B) where the multiqubit operators correspond to interaction terms described by unitaries e^{iαHd}. These multiqubit operators may be considered e.g. as a second and a subsequent qubit entity. Alternatively, for example, a first qubit entity may be considered as a first sequence of steps acting on qubits that is obtained as a result of decomposing the operator H_{d,1}, while H_{d,2} is a second qubit entity. The decomposed (or second) sequence of steps acting on qubits obtained after decomposing H_{d,2} may be combined with the first qubit entity to obtain a combined (or third) sequence of steps acting on qubits that is compressed if applicable to determine a compressed (or fourth) sequence of steps acting on qubits. The compressed sequence of steps acting on qubits may be determined as a final sequence of steps acting on qubits to be provided as a control sequence if no further qubit entities are considered.

One alternative decomposition may be selected regarding the decompositions being carried out for the first multi-qubit operator H_{d,1} and the second multi-qubit operator H_{d,2}, respectively. Once suitable sequences of steps acting on qubits are determined after the decompositions, a combined sequence of steps may be determined, where one example of such a combined sequence of steps is shown in FIG. 15C, utilizing a selected alternative decomposition for first multi-qubit operator H_{d,1} and the second multi-qubit operator H_{d,2}. Here, the two multi-qubit operators (both being four-qubit operators) have been decomposed in such a way that resulting two-qubit operators commute to the extent that all operators may be combined into pairs and merged into iSWAP gates, thus reducing circuit depth. FIG. 15D shows a result of pairing the operators of FIG. 15C into native two-qubit operators. This reduces the depth of the quantum circuit to half.

Adding to the example above, FIG. 16 shows at 16A-16D the first multi-qubit operator H_{d,1} (16A) and the second multi-qubit operator H_{d,2} (16B), as well as a third multi-qubit operator H_{d,3}=σ_{y}²σ_{z}³σ_{z}⁴σₓ⁵ (16C) and a fourth multi-qubit operator H_{d,4}=σₓ²σ_{z}³σ_{z}⁴σ_{y}⁵ (16D), which are given as further qubit entities. The third and fourth multi-qubit operators have a partial qubit overlap with the qubits of the first and second multi-qubit operators (qubits numbered 2 and 3). FIG. 16E shows a sequence of steps acting on qubits that may be determined after a plurality of steps of decomposing, joining, and/or compression have been carried out regarding the separate multi-qubit operators as qubit entities, where a selected alternative decomposition has been utilized regarding each multi-qubit operator. FIGS. 16E and 16F show that two-qubit operators (or gates) have been cancelled, which leads to further possibilities of parallelizing the gates to obtain a final sequence of steps acting on qubits that is shown in FIG. 16F, where the circuit depth has been reduced further by a factor of two.

In general, the control sequence and thus quantum circuit (sequence of quantum gates) that may be provided with the present invention may be implemented in connection with various types of quantum devices. Various methods for controlling interactions between qubits to implement the quantum gates are also available, as will be known to the skilled person. In connection with a specific quantum device and for the determined control sequence to be implementable, instructions for applying the specified gates, e.g., details on an order and/or duration of voltages to be applied may be provided.

Embodiments of the present invention may also relate to a method for determining at least one characteristic of a system. The system may be related to a multi-body interaction problem, where the system comprises at least M bodies, where M is equivalent to the number of qubits involved in at least one of the associated multi-qubit operators, and a characteristic of the system to be determined is characterized by e.g. a Hamiltonian, where the multi-qubit operator may be the Hamiltonian or the Hamiltonian may comprise a plurality of terms, where at least one the terms is the first qubit entity (first multi-qubit operator). The system may, for example, be a molecule and the multi-body problem may be solving the electronic Schrödinger equation giving the electronic structure of the molecule, with the electronic structure being the characteristic that is determined.

A multi-qubit operator H_{d} (or any further multi-qubit operators or qubit entities) may be determined based on the system and the multi-body interaction problem to be solved. A control sequence may then be determined according to methods described herein. A user of a first computing device may initiate the determining of the control sequence, and the control sequence may be delivered to a second (quantum) computing device comprising at least M qubits for implementation.

In use of the second computing device, a measurement gate may be applied to determine the characteristic of the system. The characteristic of the system could be an eigenenergy of the system. The method could be repeated multiple times in order to measure a characteristic of the system multiple times. Multiple measurements could give different eigenenergies of the system. The ground energy of the system could be estimated by finding the minimum eigenenergy from those obtained in the multiple measurements. Further characteristics of the ground state of the system could be found by repeating the method further until the estimated ground state energy is found and then applying further gates to obtain further characteristics.

The present invention may be conveniently used in connection with qubit entities that may be obtained when considering fermionic Hamiltonians and their simulation on quantum devices. The qubit entities in this case which are multi-qubit operators, may correspond to different terms of the fermionic Hamiltonian.

The electronic structure Hamiltonian Hₑₛ may in the second quantization formalism be expressed as

$${H}_{es} = {\sum }_{p , q} {h}_{pq} {c}_{p}^{†} {c}_{q} + {\sum }_{p , q , r , s} {c}_{p}^{†} {c}_{q}^{†} {c}_{r} {c}_{s} , \qquad ( 1 )$$

where p, q, r, and s may represent different fermionic modes, cᵢ and cᵢ^{\} are the annihilation and creation operators, respectively, which create and annihilate a fermion on mode i, and h_{pq}, h_{pqrs} represent one-electron and two-electron integrals, respectively, which may be considered as known constants. Quadratic terms (involving two fermionic creation/annihilation operators) in the first sum of the Hamiltonian may be referred to as hopping operators, whilst quartic terms may be referred to as interaction operators.

When characterizing physical systems for which the Hamiltonian equation is to be solved or which are to be simulated, a Hamiltonian may be considered where selected terms, connectivity, and/or spins are taken into account, leading to Hamiltonians that are sparser, i.e. less dense (meaning a lower amount of fermionic operators involved) than the electronic structure Hamiltonian Hₑₛ above, which has an order of O(M⁴) terms, where M is the total number of fermionic modes considered. One example of a sparse Hamiltonian comes from the Fermi-Hubbard model, which may be used in condensed-matter physics. Here, the Hamiltonian, where the number of terms have the order of O(M²), is:

$${H}_{FHM} = - t {\sum }_{p , q} {c}_{p}^{†} {c}_{q} + U {\sum }_{pq} {c}_{p}^{†} {c}_{q}^{†} {c}_{p} {c}_{q} , \qquad ( 2 )$$

where t and U can be considered as constants. Hamiltonians that are to be considered may vary in terms of the total number of fermionic operators (denseness/sparsity). Typically, e.g. Hamiltonians considered relating to problems in quantum chemistry may be denser than e.g. the Fermi-Hubbard Hamiltonian H_{FHM}.

As fermions are particles with half-integer spins that obey the Pauli exclusion principle, only one fermion can occupy a specific quantum state at a given time. Thus, a quantum state should be antisymmetric under exchange, and the annihilation and creation operators should anti-commute, such that:

$$\{ {c}_{p}^{†} {c}_{p} \} = {δ}_{pq} , \qquad ( 3 )$$

$$\{ {c}_{p}^{†} {c}_{q}^{†} \} = 0 , and \qquad ( 4 )$$

$$\{ {c}_{p} , {c}_{q} \} = 0. \qquad ( 5 )$$

Yet, the Pauli spin operators σᵢ, and also tensor products thereof, which are regularly used as quantum gates in quantum computers to perform qubit operations and which may be used to simulate Hamiltonians on quantum devices, anti-commute, such that

$$\{ {σ}_{p} , {σ}_{q} \} = 2 {δ}_{pq} I , \qquad ( 6 )$$

where σᵢ∈[X, Y, Z] and:

$$I = ( \begin{matrix}1 & 0 \\ 0 & 1\end{matrix} ) , \qquad ( 7 )$$

$$X = ( \begin{matrix}0 & 1 \\ 1 & 0\end{matrix} ) , \qquad ( 8 )$$

$$Y = ( \begin{matrix}0 & - i \\ i & 0\end{matrix} ) , and \qquad ( 9 )$$

$$Z = ( \begin{matrix}1 & 0 \\ 0 & - 1\end{matrix} ) . \qquad ( 10 )$$

A mapping between Hilbert spaces of a fermionic system and a collection of qubits of a quantum device may enable the representation of the fermionic system on the device. A fermion-to-qubit mapping (also called “mapping” herein) may map fermionic operators to strings of Pauli operators, which may be implemented as a quantum circuit to induce qubit interactions on a quantum device to simulate the fermionic interactions of the Hamiltonian, while preserving fermionic parity (meaning that the qubit interaction representation should comprise an equal number of interactions corresponding to creation and annihilation operators, respectively, as does the fermionic Hamiltonian). The fermionic interactions may here refer to interaction involving both interaction and hopping operators.

A fermionic Hamiltonian may then be rewritten or expressed in the form:

$$H = {\sum }_{f = 1}^{F} {a}_{j} {⊗}_{n = 1}^{N} {\tilde{σ}}_{n}^{f} \qquad ( 11 )$$

Where the product is a tensor product, aⱼ are coupling constants, the index f runs over all F operators comprised in the fermionic Hamiltonian, the index n runs over the total number of qubits in the device N, and \tilde{σ}ₙ^{f}∈[I,X,Y,Z]. A Pauli weight associated with the Hamiltonian may be determined as a maximum Pauli weight of any of the addends.

Further properties of the Hamiltonians that characterize the system they relate to are e.g. the fermionic lattice dimension and number of lattice sites (L=LₓL_{y}L_{z}, where Lₓ is the number of lattice sites in a first dimension, L_{y} is the number of lattice sites in a second dimension, and L_{z} is the number of lattice sites in a third dimension), the total number of fermionic modes (M) and the number of modes per lattice site (M/L).

Hamiltonians may range widely in terms of the degree of connectivity, i.e. which interactions between fermions are to be considered. The connectivity can include only nearest-neighbor interactions, nearest-neighbor interactions and next-nearest-neighbor interactions, or nearest-neighbor interactions, next-nearest-neighbor interactions, and higher-neighbor interactions).

Considered sites (single qubits) on a qubit layout may be assigned to represent modes of a considered Hamiltonian. A fermion-to-qubit mapping may be carried out by first defining edge (E_{pq}=−E_{qp}) and vertex (Vₚ) operators that generate a qubit connectivity graph comprising commutation relations corresponding to those of fermions. After defining such edge and vertex operators, any fermionic operator may be translated into a product of edge and vertex operators, which can then be expressed in terms of operators acting on qubits. The edge and vertex operators may be defined as:

$${E}_{pq} = - i ( {c}_{p}^{†} + {c}_{p} ) ( {c}_{q}^{†} + {c}_{q} ) \qquad ( 12 )$$

$$and$$

$${V}_{p} = - ( {c}_{p}^{†} + {c}_{p} ) ( {c}_{p}^{†} - {c}_{p} ) . \qquad ( 13 )$$

One may further show that the edge and vertex operators obey the anticommutation relations:

$$\{ {E}_{pq} , {V}_{p} \} = 0 and \qquad ( 14 )$$

$$\{ {E}_{pq} , {E}_{qr} \} = 0 , \qquad ( 15 )$$

further wherein the operators obey the following commutation relations ([A, B]=AB−BA), and anticommutation relations ([A, B]=AB+BA):

$$[ {E}_{pq} , {E}_{rs} ] = 0 , \qquad ( 16 )$$

$$[ {V}_{p} , {V}_{q} ] = 0 , and \qquad ( 17 )$$

$$[ {E}_{pq} , {V}_{r} ] = 0 \qquad ( 18 )$$

for p≠q≠r≠s.

These relations may be summed up by stating that any two distinct vertex or edge operators mutually anti-commute if they are acting on a common fermionic mode and commute otherwise. Finding a suitable fermion-to-qubit mapping may then comprise determining strings of Pauli operators to correspond to the vertex and edge operators to satisfy the relations above. A Pauli weight associated with a mapping may be determined as a maximum Pauli weight associated with any of the edge or vertex operator. A Pauli weight may refer to a number of different qubits that are associated with the operators that are utilized.

A further condition that shall be considered is that products of edge operators on closed paths {p₁, p₂, . . . }, i.e. edge operators that connect qubits to form a closed path, such as E₁₂, E₂₃, and E₃₁, should be equal to identity:

$${i}^{( \vert p \vert - 1 )} = {\prod }_{j}^{\vert p \vert - 1} {E}_{{p}_{j} {p}_{j + 1}} = 𝕀 \qquad ( 19 )$$

Regarding the above condition, an initial state may be selected such that it is in the +1 eigenspace of the product of edge operators over all the closed paths. As long as this condition on the initial state is satisfied, equation 19 does not have to be considered when constructing mappings.

Suitable edge and vertex operators may be determined by for instance determining a plurality of different combinations (such as all possible combinations) of tensor products of Pauli operators and selecting a set of operators that satisfy selected criteria, such as at least the anticommutation and commutation criteria.

After determining a set of suitable edge and vertex operators, these may be utilized in mapping each interaction between fermionic modes to a qubit operator and find expressions corresponding to the fermionic operators of a considered problem Hamiltonian.

To determine a set of qubit interactions that correspond to the interactions between fermionic modes, relationships between edge and vertex operators, fermionic Majorana operators γᵢγ̅ᵢ and the fermionic annihilation and creation operators may be utilized. Such relationships are given by:

$${V}_{p} = - i ( {γ}_{p} {\overline{γ}}_{p} ) \qquad ( 20 )$$

$${E}_{pq} = - i ( {γ}_{p} {γ}_{q} ) \qquad ( 21 )$$

$${γ}_{p} = ( {c}_{p} + {c}_{p}^{†} ) \qquad ( 22 )$$

$${\overline{γ}}_{p} = \frac{1}{i} ( {c}_{p} - {c}_{p}^{†} ) \qquad ( 23 )$$

By using commutation properties of these edge, vertex, Majorana, and annihilation and creation operators, expressions for the different fermionic interactions that are required for each use case may be determined. Some examples may be given as:

$${c}_{p}^{†} {c}_{q} \to \frac{i}{4} ( 1 + {V}_{q} - {V}_{p} - {V}_{p} {V}_{q} ) {E}_{pq} , \qquad ( 24 )$$

$${c}_{p}^{†} {c}_{q}^{†} {c}_{r} {c}_{s} \to \frac{1}{16} ( 1 + {V}_{s} - {V}_{q} - {V}_{r} {V}_{s} + {V}_{r} - {V}_{p} + {V}_{r} {V}_{s} + {V}_{p} {V}_{q} - {V}_{q} {V}_{r} - {V}_{p} {V}_{r} - {V}_{p} {V}_{s} - {V}_{q} {V}_{r} {V}_{s} + {V}_{p} {V}_{q} {V}_{s} - {V}_{p} {V}_{r} {V}_{s} + {V}_{p} {V}_{q} {V}_{r} + {V}_{p} {V}_{q} {V}_{r} {V}_{s} ) {E}_{pq} {E}_{rs} , \qquad ( 25 )$$

$${c}_{p}^{†} {c}_{q} + {c}_{q}^{†} {c}_{p} \to \frac{i}{2} ( {V}_{q} - {V}_{p} ) {E}_{pq} , and \qquad ( 26 )$$

$${c}_{p}^{†} {c}_{q}^{†} {c}_{r} {c}_{s} + {c}_{p}^{†} {c}_{r}^{†} {c}_{q} {c}_{s} + {c}_{r}^{†} {c}_{s}^{†} {c}_{p} {c}_{q} + {c}_{s}^{†} {c}_{q}^{†} {c}_{r} {c}_{p} \to \frac{1}{4} ( {V}_{p} {V}_{q} - {V}_{p} {V}_{r} + {V}_{r} {V}_{s} - {V}_{s} {V}_{q} ) {E}_{pr} {E}_{qs} . \qquad ( 27 )$$

A consideration that may be used in the determination of a mapping is that not all possible edges, i.e. not all possible connectivities between fermionic modes, are required to be directly represented in the connectivity graph. It may suffice that the qubit sites corresponding to an any edge are connected by a path comprising of intermediate edge operators, to form a “composite” edge operator, as:

$${E}_{pr} = {E}_{pq} {E}_{qr} . \qquad ( 28 )$$

Yet, it is also possible to dynamically alter the connectivity graph itself by using fermionic swap (fSWAP) operations, which exchange the position of two fermionic modes which are connected by an edge. Such an fSWAP operator is defined as:

$${fSWAP}_{pq} = {e}^{\frac{i π}{4} {V}_{p}} {e}^{\frac{i π}{4} {V}_{q}} {e}^{\frac{π}{4} {V}_{p} {E}_{pq}} {e}^{\frac{π}{4} {V}_{p} {E}_{pq} {V}_{q}} \qquad ( 29 )$$

Through an fSWAP operator, modes of the Hamiltonian which interact with each other may be brought closer together, thus reducing the Pauli weights of the corresponding Hamiltonian operators. However, it may be taken into account that this comes at the cost of having to implement the fSWAP operations themselves, which may increase the computational effort.

There are various considerations or criteria that may be taken into account in the selection of the edge and vertex operators and thus the determination of the fermion-to-qubit mapping. The favoring of some criterion or criteria may lead to weaknesses relating to other aspects. Criteria may be related to performance aspects in terms of computational resources required to carry out a simulation/calculation on a quantum device utilizing the determined mapping and a control sequence determined therefrom (e.g. circuit depth, number of two-qubit gates, qubit-to-mode ratio i.e. how many qubits are required to encode one fermionic mode, and/or Pauli weights), limitations imposed by hardware aspects (such as a number of qubits and/or connectivity of a qubit layout that is to be utilized and/or types of one- and/or two-qubit gates allowed, depending on which gates are native to the hardware in question), error-related aspects relating to known or estimated errors or requirements for error correction relating to the calculations performed via the quantum device, and/or versatility aspects relating to the types of Hamiltonians the mapping may be applied to. Therefore, it may not be possible to determine a fermion-to-qubit mapping that is optimal in performance in connection with any type of Hamiltonian, any type of fermionic system, and any type of hardware.

In the following, a fermion-to-qubit mapping that is well adapted for use on hardware comprising a square lattice qubit layout, where one qubit is connectable with at most four other qubits, will be introduced, where the mapping further has low-weight composite edge operators for further-neighbor (over NN) edges, enabling simulation of e.g. a broad class of two-dimensional fermionic lattices from condensed matter physics. In addition, the selected mapping is conveniently utilized with the presently disclosed methods comprising decomposing, combining, and/or compressing, to provide low depth circuits for simulating the fermionic Hamiltonian systems.

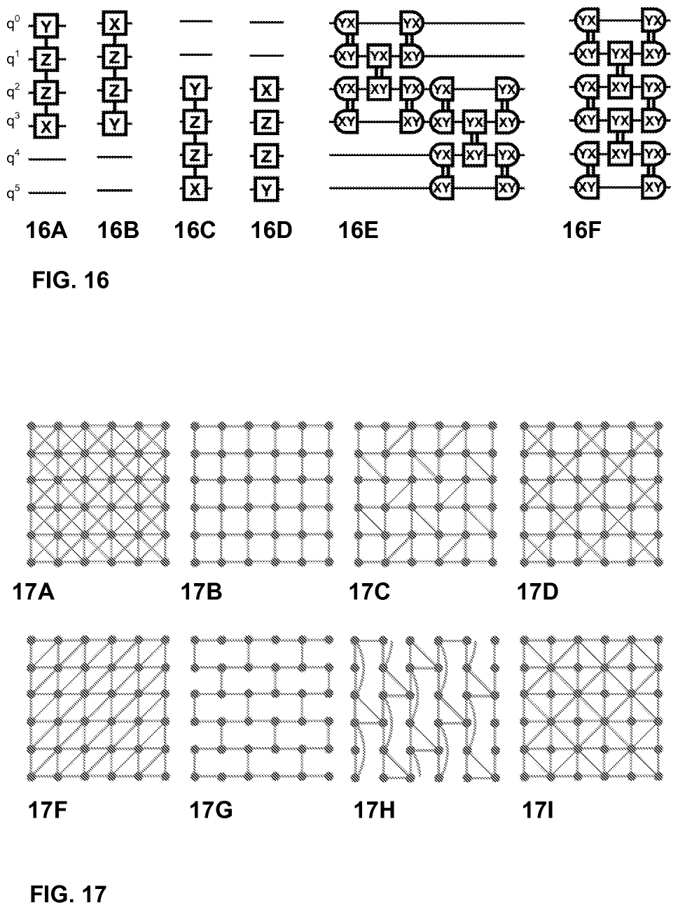

The fermion-to-qubit mapping presented here that maps a square fermionic lattice geometry to a square lattice qubit layout, provides an effective strategy for embedding also the fermionic lattice geometries shown in FIGS. 17A-17I. The figures show alternative fermionic lattice geometries (in two dimensions) and associated connectivities between sites that may be efficiently embedded into a square lattice qubit layout with the projection, association of fermionic sites with physical qubits, and mapping of the present invention. FIG. 17A shows a square lattice with NNN connectivity, FIG. 17B shows a square lattice with NN connectivity, FIG. 17C shows a Shastry-Sutherland lattice, FIG. 17D shows a checkerboard lattice, FIG. 17F shows a triangular lattice, FIG. 17G shows a honeycomb lattice, FIG. 17H shows a Kagome lattice, and FIG. 17I shows a tetrakis lattice. The method of the present invention may maximally utilize the available qubits or available qubits to associate with fermionic lattice sites that are present in a square lattice qubit layout. Within at least a selected subset or selected square lattice portion of a square lattice layout of a quantum device, all (physical) qubits may be utilized in the projected lattice geometry.

The present invention may enable determining edge operators that connect two physical qubits through a vertical stack of ancilla qubits. Here, multiple vertical edges may be composed to reach a further neighbor (which are not connected by a direct determined edge operator) and the cost may only grow by one ancilla qubit for each unit of distance on the fermionic graph.

A method of providing a fermion-to-qubit mapping may comprise receiving parameters of a fermionic Hamiltonian to be simulated, the parameters comprising at least a number of fermionic lattice sites L, a number of fermionic modes m in the fermionic lattice, and fermionic operators corresponding to interactions between the fermionic modes m.

In the mapping, the fermionic lattice may be projected to a qubit layout of a quantum device such that every fermionic mode is assigned to a qubit of the quantum device, wherein such a qubit is referred to as a physical qubit P, wherein the projection between the fermionic modes and the physical qubits is one to one. Additionally, to resolve anticommutation relations, a plurality of further qubits of the quantum device are referred to as ancilla qubits A, wherein said ancilla qubits A are not assigned with any fermionic mode.

Then, each physical qubit P may be associated with at least one edge operator E and one vertex operator V. Each fermionic operator may then be mapped to a qubit operator based on the edge operators E and vertex operators V. These qubit operators may correspond to qubit entities, with at least one of the qubit operators being a second qubit entity.

The physical qubits P and the ancilla qubits A may be arranged onto horizontal single lines of the two-dimensional square lattice of the qubit layout, such that each horizontal single line comprises at least one string P′ and at least one ancilla qubit A, wherein each string P′ comprises one or more physical qubits P, and wherein the arrangement of physical qubits P and ancilla qubits A in each single horizontal line of the qubit layout is the same.

Preferably, in a row of qubits, there are at most two consecutive ancilla qubits A. More may be utilized, but a maximum of two consecutive ancilla qubits may be more efficient.

The qubits may further be arranged into a pattern, wherein the pattern is repeated successively within the single horizontal line of qubits, wherein the pattern is selected from the group of P′A, P′P′A, P′P′AA, and P′AA.

A row of qubits may be obtained by selecting a pattern and repeating the pattern in the horizontal dimension to obtain a desired/determined total number of strings P′ and ancilla qubits A in the row. A pattern may be repeated a selected number of times and a pattern may also be repeated such that at a beginning and/or end of a row or horizontal single line of qubits, a pattern is only partially provided. For example, a row of qubits with a pattern P′P′A may comprise strings P′ and ancilla qubits A arranged as: P′AP′P′AP′P′AP′, i.e. with the pattern being repeated in full two times and the sequence being “cut” as P′A in the beginning of the row and as P′ at the end of the row.

A number of consecutive physical qubits P that the string P′ corresponds to or comprises may be obtained based on the fermionic system and/or Hamiltonian that is considered. For instance, if a fermionic system comprises two fermionic modes per fermionic lattice site, a pattern of P′AA will correspond to PPAA when implemented in the row of qubits in the qubit layout.

A row of qubits in the horizontal direction may correspond to a sequence of qubits that may be obtained through further considerations regarding a fermionic system. Obtained or known information may indicate a number of fermionic lattice sites in two or three dimensions, comprising a number of fermionic lattice sites in a first dimension L₁, a number of fermionic lattice sites in a second dimension L₂, and optionally a number of fermionic lattice sites in a third dimension L₃, where a total number of fermionic lattice sites is L=L₁L₂ if two dimensions are considered or L=L₁L₂L₃ if three dimensions are considered.

Each fermionic mode of the fermionic Hamiltonian can be identified by indices i, j, k, indicating fermionic lattice site position along the respective dimensions, where i=[1, L₁], j=[1, L₂], k=[1, L₃], and the number of fermionic modes in each of the fermionic lattice sites identified by indices i, j, k can be labelled as Mᵢⱼₖ such that the total number of fermionic modes in the fermionic lattice is M=Σᵢ₌₁^{L}^{₁}Σⱼ₌₁^{L}^{₂}Σₖ₌₁^{L}^{₃}Mᵢⱼₖ. Here, each fermionic mode of the fermionic Hamiltonian can be identified by four indices i, j, k, l, where l=[1, Mᵢⱼₖ]. Projecting the fermionic lattice onto the square lattice qubit layout of the quantum device may comprise assigning each fermionic mode, identified by the four indices i, j, k, l, of the fermionic lattice to a physical qubit Pᵢⱼₖₗ of the quantum device, where the indices of each physical qubit identify the fermionic mode with which the physical qubit is assigned.

The physical qubits Pᵢⱼₖₗ, each assigned with a fermionic mode identified by the indices i, j, k, l, may be arranged within the qubit layout such that:
each row of the qubit layout comprises L₁ strings P′, each string denoted as P′ᵢⱼ to indicate that the string comprises a number of physical qubits Pᵢⱼₖₗ assigned with fermionic modes associated with fermionic lattice sites with position indices i and j, where the number of physical qubits within a string P′ᵢⱼ is equal to Σₖ₌₁^{L}^{₃}Mᵢⱼₖ,
each physical qubit with a lower index i is arranged, in the horizontal dimension, before any physical qubit with a higher index i,
the number of rows in the qubit layout that is participating in the projecting is equivalent to L₂, and each physical qubit with a lower index j is arranged, in the vertical dimension, before any physical qubit with a higher index j, and
physical qubits within each string P′ are associated with varying indices k and l and arranging their respective order depending on the fermionic interactions.

Physical qubits within any string P′ in the horizontal dimension may be arranged such that the order of physical qubits with indices k and l is opposite in the consecutive string P′.

If the fermionic Hamiltonian describes a system with two or more spin types within a fermionic lattice site, the modes Mᵢⱼₖ per each fermionic lattice site may be further assigned into a number of orbitals o, each orbital comprising a number of spins s, where Mᵢⱼₖ=o*s, where the physical qubits assigned with fermionic modes with the spins of one orbital are each separated by one physical qubit and where if the l indices of the physical qubits assigned with an orbital are odd, the fermionic modes associated with the physical qubits with the indices l are arranged so that increasing index l is associated with an increasing spin type s, whereas if the l indices of the physical qubits representing an orbital are even, the fermionic modes associated with the physical qubits with indices l may be arranged so that increasing index l is associated with a decreasing spin type s.

The associating of physical qubits with edge and vertex operators may take into account native gates of the quantum device at which the obtained control sequence is to be implemented. In one embodiment, the physical qubits in a row of qubits in the horizontal dimension may be grouped into pairs of physical qubits alternatingly labelled as even or odd, wherein ancilla qubits are not considered, and neighboring even and odd pairs share a physical qubit, wherein the associating each physical qubit with at least one edge operator may then comprise:
for each even pair of physical qubits p and q and the one or more ancilla qubits between them if present, define an even horizontal edge operator E_{pq}^{H1} associated with said qubits, wherein
   if p and q are direct neighbors not separated by an ancilla qubit, E_{pq}^{H1} is a product of two Pauli operators of second type acting on physical qubits p and q, respectively, preferably wherein E_{pq}^{H1}=XₚX_{q}
   if p and q are separated by one ancilla qubit a, E_{pq}^{H1} is a product of a Pauli operator of second type acting on physical qubit p, a Pauli operator of first type acting on ancilla qubit a, and a Pauli operator of second type acting on physical qubit p, preferably wherein E_{pq}^{H1}=XₚZₐX_{q},
   if p and q are separated by two ancilla qubits a and b, E_{pq}^{H1} is a product of a Pauli operator of second type acting on physical qubit p, a Pauli operator of first type acting on ancilla qubit a, a Pauli operator of first type acting on ancilla qubit b, and a Pauli operator of second type acting on physical qubit p, preferably wherein E_{pq}^{H1}=XₚZₐZ_{b}X_{q},
for each pair of odd physical qubits p and q and the one or more ancilla qubits between them if present, define an odd horizontal edge operator E_{pq}^{H2} associated with said qubits, wherein
   if p and q are direct neighbors not separated by an ancilla qubit, E_{pq}^{H2} is a product of two Pauli operators of third type acting on physical qubits p and q, respectively, preferably wherein E_{pq}^{H2}=YₚY_{q},
   if p and q are separated by one ancilla qubit a, E_{pq}^{H2} is a product of a Pauli operator of third type acting on physical qubit p, a Pauli operator of first type acting on ancilla qubit a, and a Pauli operator of third type acting on physical qubit p, preferably wherein E_{pq}^{H2}=YₚZₐY_{q},
   if p and q are separated by two ancilla qubits a and b, E_{pq}^{H2} is a product of a Pauli operator of third type acting on physical qubit p, a Pauli operator of first type acting on ancilla qubit a, a Pauli operator of first type acting on ancilla qubit b, and a Pauli operator of third type acting on physical qubit p, preferably wherein E_{pq}^{H2}=YₚZₐZ_{b}Y_{q},
for each pair of physical qubits p and q, which in the vertical dimension are direct neighbors without any physical or ancilla qubits between them, define a vertical edge operator E_{pq}^{V} associated with said qubits, wherein
   if ancilla qubits a and b are direct neighbors of p and q in the horizontal dimension in a first direction, with p and q having no other ancilla qubits as direct horizontal neighbors, and wherein a and b are associated with even horizontal edge operators, E_{pq}^{V} is a product of a Pauli operator of the second type acting on physical qubit p, a Pauli operator of the second type acting on ancilla qubit a, a Pauli operator of the third type acting on ancilla qubit b, and a Pauli operator of the second type acting on physical qubit q, preferably wherein E_{pq}^{V}=XₚXₐY_{b}X_{q},
   if ancilla qubits a and b are direct neighbors of p and q in the horizontal dimension in the first direction, with p and q having no other ancilla qubits as direct horizontal neighbors, and wherein a and b are associated with odd horizontal edge operators, E_{pq}^{V} is a product of a Pauli operator of the third type acting on physical qubit p, a Pauli operator of the second type acting on ancilla qubit a, a Pauli operator of the third type acting on ancilla qubit b, and a Pauli operator of the third type acting on physical qubit q, preferably wherein E_{pq}^{V}=YₚXₐY_{b}Y_{q},
   if ancilla qubits a and b are direct neighbors of p and q in the horizontal dimension in a second direction, with p and q having no other ancilla qubits as direct horizontal neighbors, and wherein a and b are associated with even horizontal edge operators, E_{pq}^{V} is a product of a Pauli operator of the second type acting on physical qubit p, a Pauli operator of the third type acting on ancilla qubit a, a Pauli operator of the second type acting on ancilla qubit b, and a Pauli operator of the second type acting on physical qubit q, preferably wherein E_{pq}^{V}=XₚYₐX_{b}X_{q},
   if ancilla qubits a and b are direct neighbors of p and q in the horizontal dimension in the second direction, with p and q having no other direct ancilla qubits as horizontal neighbors, and wherein a and b are associated with odd horizontal edge operators, E_{pq}^{V} is a product of a Pauli operator of the third type acting on physical qubit p, a Pauli operator of the third type acting on ancilla qubit a, a Pauli operator of the second type acting on ancilla qubit b, and a Pauli operator of the third type acting on physical qubit q, preferably wherein E_{pq}^{V}=YₚYₐX_{b}Y_{q},
   if p and q are direct neighbors of ancilla qubits a and b in the horizontal dimension in the first direction, with ancilla qubits c and d as direct neighbors in the second direction,
      for the first direction: E_{pq}^{V} is a product of a Pauli operator of the second type acting on physical qubit p, a Pauli operator of the second type acting on ancilla qubit a, a Pauli operator of the third type acting on ancilla qubit b, and a Pauli operator of the second type acting on physical qubit q, preferably wherein E_{pq}^{V}=XₚXₐY_{b}X_{q}, or E_{pq}^{V} is a product of a Pauli operator of the third type acting on physical qubit p, a Pauli operator of the second type acting on ancilla qubit a, a Pauli operator of the third type acting on ancilla qubit b, and a Pauli operator of the third type acting on physical qubit q, preferably wherein E_{pq}^{V}=YₚXₐY_{b}Y_{q},
      for the second direction: E_{pq}^{V} is a product of a Pauli operator of the second type acting on physical qubit p, a Pauli operator of the third type acting on ancilla qubit c, a Pauli operator of the second type acting on ancilla qubit d, and a Pauli operator of the second type acting on physical qubit q, preferably wherein E_{pq}^{V}=XₚY_{c}X_{d}X_{q}, or E_{pq}^{V} is a product of a Pauli operator of the third type acting on physical qubit p, a Pauli operator of the third type acting on ancilla qubit c, a Pauli operator of the second type acting on ancilla qubit d, and a Pauli operator of the third type acting on physical qubit q, preferably wherein E_{pq}^{V}=YₚY_{c}X_{d}Y_{q}.

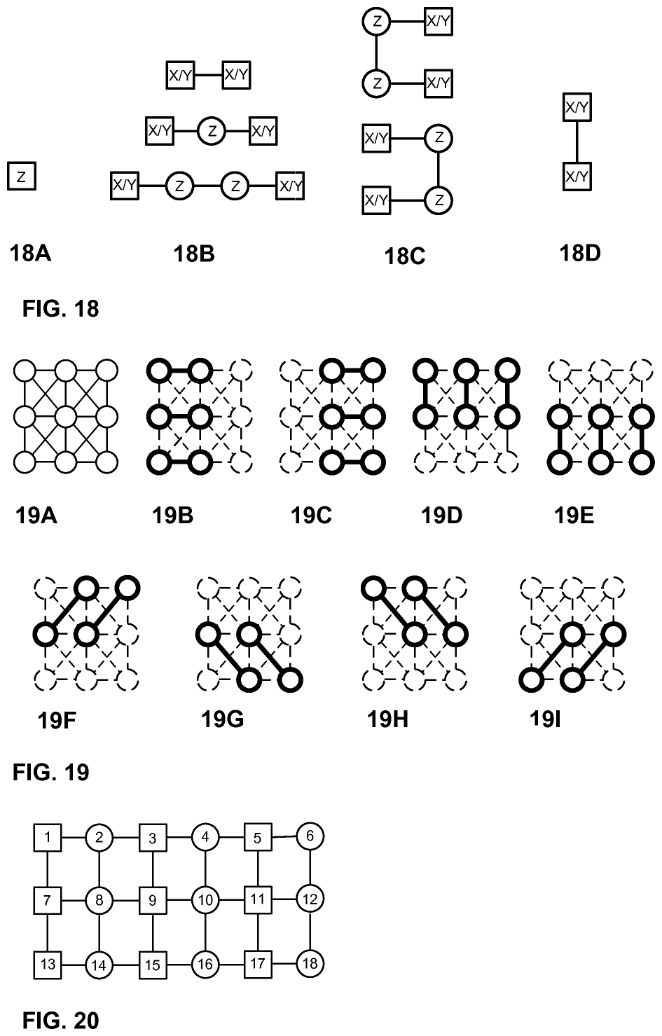

FIG. 18 shows advantageous selections of edge and vertex operator types.

Here, selection of Pauli operator types for vertex operators is Vₚ=Zₚ, where Zₚ is a Pauli operator σ_{Z} acting on qubit p. FIG. 18A depicts the vertex operator, while FIG. 18B depicts the possibilities for horizontal edge operators and FIG. 18C shows possible vertical edge operators which may be used in connection with most qubits and qubit layouts. FIG. 18D shows a vertical edge operator that may be used in rare cases when the two associated physical qubits P may be connected without ancilla qubits A. This situation may arise at the borders of a finite system, e.g. in connection with a honeycomb type lattice geometry, where it is possible that no ancilla qubits are required to be used between at least some of the possible pairs of physical qubits at the edges of the qubit lattice.

The different possibilities for edge operators depend on the placement of ancilla qubits in the vicinity of the considered physical qubits. In FIG. 18, physical qubits (or physical qubit strings P′) are depicted as squares and ancilla qubits as circles, while the notations X/Y and X/Y in connection with physical qubits in the same operators indicate that both qubits are acted on by operators that correspond to either σ_{X} operators or σ_{Y} operators (in figures that follow, the notation X/Y and Y/X in connection with the physical qubits in the same operator indicate that one qubit is acted on by an operator corresponding to either σ_{X} or σ_{Y}, while the other qubit is acted on by an operator σ_{X} or σ_{Y} which is different from the operator acting on the one qubit). These operator selections are advantageous for quantum devices where native gates correspond to e^{iαZ}^{ₚ}^{Z}^{_{q}} and e^{iα(X}^{ₚ}^{X}^{_{q}}^{+Y}^{ₚ}^{Y}^{_{q}}⁾. Such operator selections are also advantageous for quantum devices where native gates correspond to fSIM gates (covering both of the previous and also further gates), where

$${fSIM}_{ij} ( θ , ϕ ) = {e}^{i \frac{θ}{2} ( {X}_{i} {X}_{j} + {Y}_{i} {Y}_{j} ) + i \frac{ϕ}{4} ( {Z}_{i} {Z}_{j} + {Z}_{i} {Z}_{j} )} .$$

FIG. 18B shows that Pauli strings corresponding to horizontal edge operators may be formed by either σ_{X} or σ_{Y} operators on two qubits at the ends combined with up to two intermediate ancilla qubits being acted on by σ_{Z} operators. The σ_{X} and σ_{Y} may be altered between neighboring horizontal edges, which ensures that they mutually anti-commute. One thus has the choice between horizontal edges of Pauli weight between two and four, depending on the selection of the pattern to be used.

As seen from FIG. 18C, all vertical edge operators as depicted in connection with a qubit layout usually have a square-like shape comprising two physical qubits and two ancilla qubits. The physical qubits may reside either to the left or to the right of the ancilla qubits and similarly to the horizontal edge operators acting on ancilla qubits as well as physical qubits, both Pauli operators acting on physical qubits in vertical edge operators should carry either a σ_{X} or σ_{Y}, the choice of which should be the same as horizontal edge operators to be utilized in the same mapping, which horizontal edge operators they shall anti-commute with.

FIGS. 19-21 illustrate one example of applying the method of the present invention for simulation of the spinless Fermi-Hubbard model (one mode per fermionic lattice site) with NN and NNN hoppings/interactions. The considered example is for a 3×3 fermionic lattice (L₁=3, L₂=3, L₃=1) that is projected onto a qubit layout that has three horizontal rows, with one row having an arrangement of physical qubits and ancilla qubits of: PAPAPA (a pattern of PA then being used, with P′ being equal to P since only one mode per lattice site is considered).

FIG. 19 shows at 19A the fermionic lattice and the considered connectivity. FIGS. 19B-19I specify (highlight with bold lines) the different hopping terms on the fermionic lattice that are to be considered: first horizontal interactions at 19B, second horizontal interactions at 19C, first vertical interactions at 19D, second vertical interactions at 19E, first diagonal interactions at 19F, second diagonal interactions at 19G, third diagonal interactions at 19H, and fourth diagonal interactions at 19I. In FIG. 19, the circles represent different fermionic lattice sites. In the separate subfigures, operators which may be applied in parallel are depicted on the same lattice.

FIG. 20 illustrates a qubit layout that may be used to simulate a fermionic Hamiltonian that involves the 3×3 fermionic lattice and interactions shown in FIG. 19. In FIG. 20, squares represent physical qubits and circles represent ancilla qubits, with FIG. 20 showing also a numbering of qubits that may be employed.

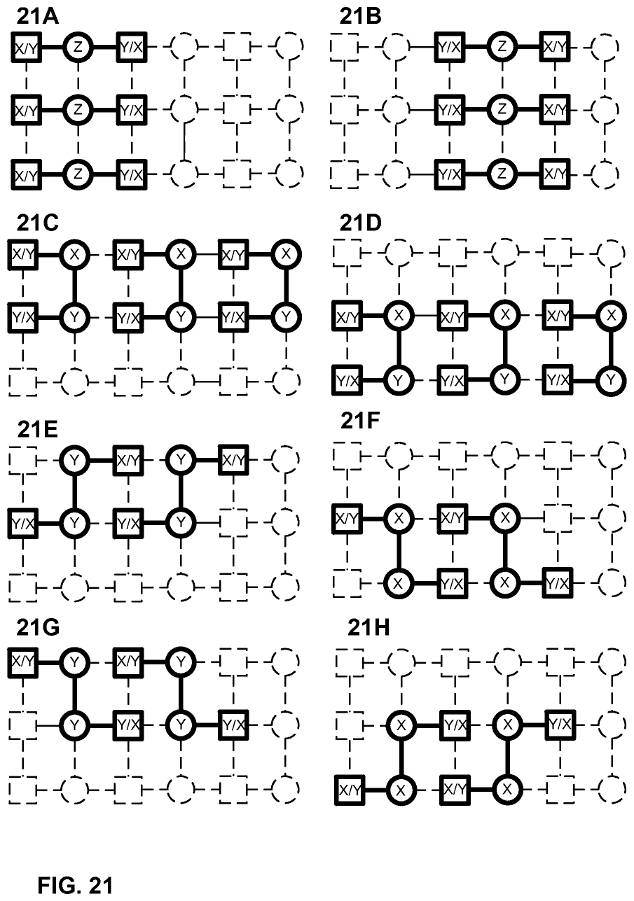

FIGS. 21A to 21H depict hopping operators (i.e. operators comprising one edge operator multiplied by one vertex operator) that may be determined that can be utilized in a fermion-to-qubit mapping and associated determination of qubit operators involving a qubit layout of FIG. 20 and corresponding to the fermionic lattice and fermionic interactions of FIG. 19.

The hopping operator depicted by FIG. 21A corresponds to the first horizontal interactions of FIG. 19B, FIG. 21B corresponds to the second horizontal interactions of FIG. 19C, FIG. 21C corresponds to the first vertical interactions of FIG. 19D, FIG. 21D corresponds to the second vertical interactions of FIG. 19E, FIG. 21E corresponds to the first diagonal interactions of FIG. 19F, FIG. 21F corresponds to the second diagonal interactions of FIG. 19G, FIG. 21G corresponds to the third diagonal interactions of FIG. 19H, and FIG. 21H corresponds to the fourth diagonal interactions of FIG. 19I.

Horizontal or vertical hopping operators may correspond to VᵢEᵢⱼ, where Eᵢⱼ is the corresponding edge operator in the horizontal or vertical direction, whilst diagonal hopping operators may be obtained as composite operators and may correspond to VᵢEⱼₖEₖⱼ, where one of the edge operators is a corresponding horizontal edge operator and the other edge operator is a corresponding vertical edge operator.

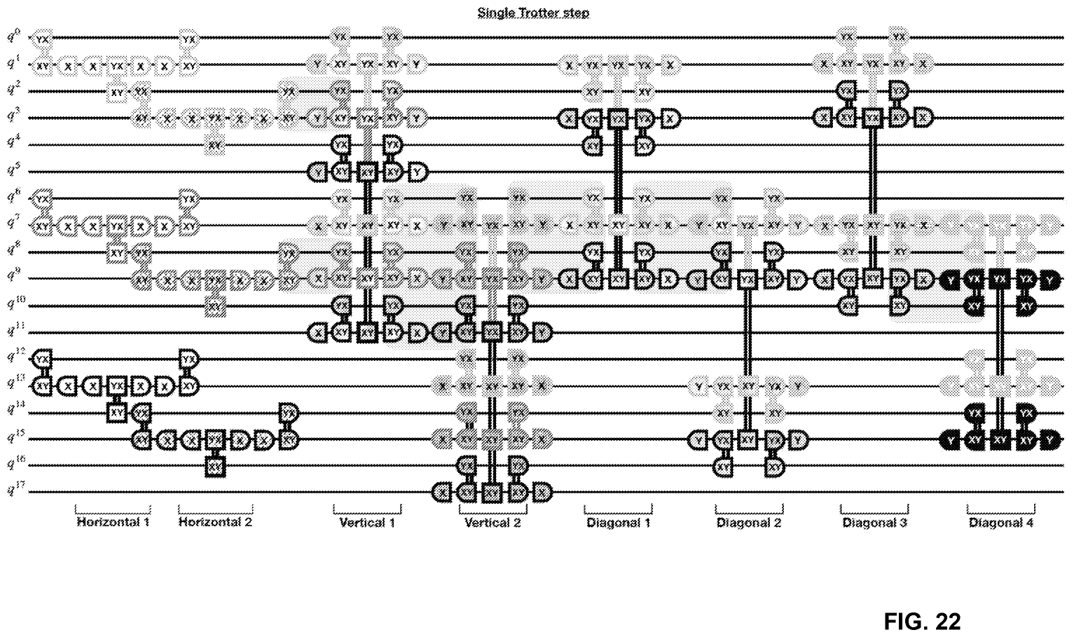

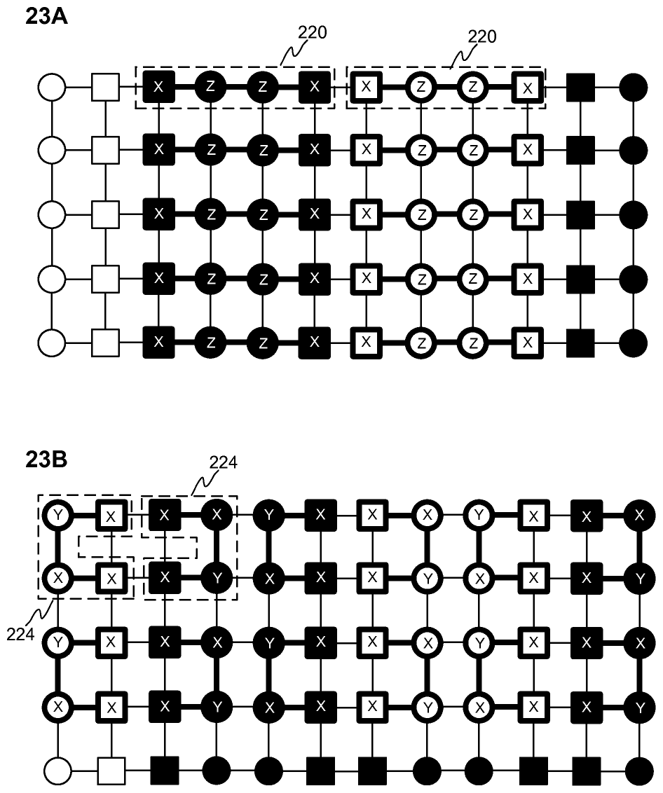

To arrive at the circuit of FIG. 22, which may be determined as a final sequence of steps acting on qubits that may be provided as a control sequence for carrying out qubit interactions on a quantum device, the following procedure may be followed.

First, as many parallel blocks of gates as possible may be placed. For example, all the horizontal hoppings of type shown in FIG. 21A may be grouped, then the horizontal hoppings of type shown in FIG. 21B, and groups may thereafter be added until all groups are included. Each of these hoppings will consist of a sum of Hermitian conjugates. Operator pairs obtained from mapping the sum of Hermitian conjugate hopping terms may be combined. One can place together those hopping terms that lead to maximal cancellation and compression of gates as can be seen in FIG. 22, all operators have also rotated (with single-qubit gates) to be of a form that may be considered as a native gate. Parallel operators acting on distinct sets of qubits can then be collected into layers and applied simultaneously.

On top of the compression considered above, some more cancellations may be made between Trotter layers. This way, an extra reduction may be obtained when simulating many Trotter steps. This reduction will depend on the depth of the two longest hopping terms and on whether they can be placed the boundaries without losing compression.

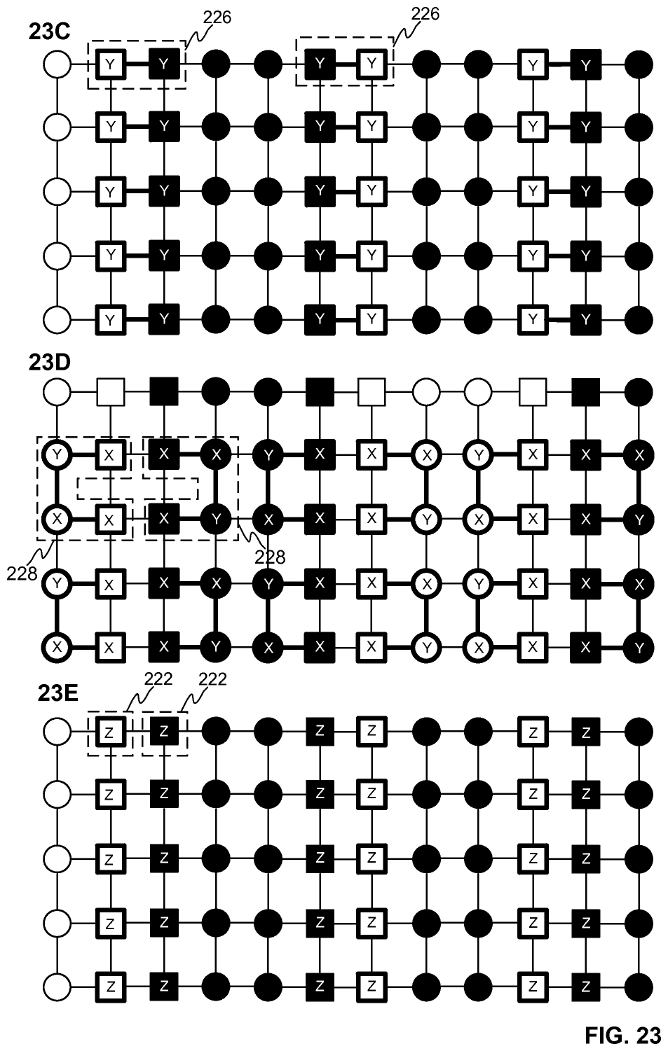

To show how the mapping shall be applied when more than one mode is considered per fermionic lattice site, FIG. 23 depicts an example of edge and vertex operators that may be utilized when a pattern P′AA is chosen and a fermionic system comprises two modes per lattice site. Thus in this case, the string P′ corresponds to two physical qubits, i.e. PP. Squares represent physical qubits P and circles represent ancilla qubits A. In this example, it is considered that each lattice site comprises one orbital, each with two spin types, here “up” and “down”. Squares that are filled (black) correspond to one spin type mode, e.g. up, while squares that are empty (no fill) correspond to the other spin type mode, e.g. down.

FIGS. 23A and 23C show horizontal edge operators, FIGS. 23B and 23D show vertical edge operators, and FIG. 23E shows vertex operators. The group of operators in each separate figure may be implemented in parallel, as they are acting on different qubits. The operators are depicted through marking associated qubits with letters corresponding to the associated Pauli operator types and showing associated qubits and connections with bold lines. The selected areas 220 and 226 point out horizontal edge operators, 224 and 228 point out vertical edge operators, and 222 points out vertex operators, each shown for both spin up and spin down modes. Each edge operator thus acts on or involves physical qubits that are assigned with fermionic modes that correspond to each other on different fermionic lattice sites.

It may also be noted that if the fermionic lattice is three-dimensional, then each lattice site in the third dimension (L₃) may be treated, in the projecting, in the same way as further modes or orbitals of the fermionic lattice sites in the first dimension. Thus, a string P′ may comprise a number of physical qubits P that corresponds to a number of modes comprised in an associated lattice site in the first dimension plus a number of physical qubits that corresponds to a number of modes comprised in each fermionic lattice site in the third dimension. However, it may be noted that in this case the obtained circuit depth may no longer be constant depth or scale linearly with the size of the fermionic system, but the circuit depth will scale linearly with the third dimension and the number of fermionic modes per lattice site.

In cases where more than one fermionic mode per fermionic lattice site is considered, the different modes may relate to different orbitals and/or different spin types of the same orbital. In these cases however, the string P′ may then comprise a plurality of consecutive physical qubits P that form a chain of modes. The modes associated with physical qubit at the ends of one chain or string P′ may be readily involved in interactions with one or more modes of further fermionic lattice sites that are associated with physical qubits of a further string P′, where such interactions are made possible through edge and vertex operators that may connect the qubits associated with the modes.

In some cases, there may thus be a chain of fermionic modes associated with the qubits within in a row, where one or more modes are initially internal modes that are positioned at middle sites in the string and are associated with internal physical qubits of the string P′. Such internal modes are advantageously repositioned such that they may be located at an end position of the chain of fermionic modes in order to be involved in one or more interactions.

Repositioning of fermionic modes may be carried out by utilizing fSWAP operators, so that one or more internal modes are shifted to the first direction or second direction (left or right) along the row of qubits. A network of fSWAP operators comprising M/L−2 parallel fSWAP layers may swap fermionic modes within a string P′ of M/L modes by alternating two layers of fSWAPs between all neighboring qubit pairs, which may be alternatingly labelled as either even (for instance physical qubits numbered as 2n, 2n+1) or odd (e.g. physical qubits numbered as 2n+1, 2n+2).

The assigning of modes to an arrangement of a row of qubits may comprise ordering of the modes so that an fSWAP network may be efficiently used to bring the relevant modes next to each other on the connectivity graph corresponding to the qubit layout projection. The assigning of modes as disclosed herein may lead to efficient simulation of fermionic Hamiltonians, as a plurality of operations may be performed in parallel. Advantageously, there may be no physical qubits assigned with fermionic modes that do not participate in qubit interactions during a layer of a control sequence or quantum circuit where qubit interactions corresponding to fermionic interactions are applied.

Table 1 below shows how the mappings presented herein may utilize the described decomposition and compression techniques to provide circuit depths that are lower than with a prior art Derby-Klassen (DK) mapping. The table considers circuit depth per Trotter step and shows results for several different spinful fermionic lattices with a selected pattern P′AA for mappings of the present disclosure. The decomposition and compression techniques presented herein have also been carried out here for the DK mappings (and may also be readily used with further prior art mappings). However, table 1 exhibits how the mappings disclosed above may results in even lower circuit depth than the e.g. DK mapping, even when decomposition and compression are applied to both.

TABLE 1
Summary of depths for the implementation of a Trotter
step circuit for different spinful fermionic lattices
using fSIM(θ, ϕ) native two-qubit gate.

| Lattice type | P′AA | DK |
|---|---|---|
| Honeycomb | 9 | 17 |
| Square | 11 | 21 |
| Shastry- | 19 | 24 |
| Sutherland | | |
| Kagome | 22 | 36 |
| Triangular | 22 | 46 |
| Checkerboard | 22 | 30 |
| Tetrakis | 23 | 46 |
| NNN square | 30 | 74 |

In summary, it may thus be advantageous to determine fermion-to-qubit mappings that provide qubit operators where the presently disclosed decomposition and compression are conveniently used to obtain circuit depths that are effectively reduced.

The method of the present invention may thus be used for determining a control sequence for simulating a fermionic Hamiltonian, where the method may further comprise determining a plurality of fermion-to-qubit mappings, determining a plurality qubit entities associated with each fermion-to-qubit mapping, for which final control sequences are determined, and selecting a control sequence that provides a lowest circuit depth.

1. A computer-implemented method for determining a control sequence for performing a series of steps acting on a plurality of qubits on a quantum device, the method comprising:
obtaining a plurality of qubit entities, comprising at least a first qubit entity and a second qubit entity, wherein a qubit entity comprises a sequence of steps acting on qubits, and wherein at least said second qubit entity comprises a single multi-qubit interaction term,
decomposing the multi-qubit interaction term of the second qubit entity and determining a decomposed sequence of steps acting on qubits, so that the multi-qubit interaction term has been decomposed into a sequence of single qubit and/or two-qubit interaction terms,
combining the first sequence of steps acting on qubits of the first qubit entity with the decomposed sequence of steps acting on qubits of the second qubit entity to obtain a combined sequence of steps acting on qubits,
compressing the combined sequence of steps acting on qubits to provide a compressed sequence of steps acting on qubits comprising only single-qubit and/or two-qubit interactions, wherein a number of steps acting on qubits in the compressed sequence of steps acting on qubits is less than or equal to the number of steps acting on qubits in the combined sequence of steps acting on qubits,
providing a control sequence for performing a sequence of steps acting on qubits, said control sequence comprising at least the compressed sequence of steps acting on qubits.

2. The method of claim 1, wherein the first qubit entity comprises a first sequence of steps acting on qubits comprising steps comprising single and/or two qubit interaction terms and/or no interactions between qubits.

3. The method of claim 1, wherein the decomposing comprises iterative decomposition steps of multi-qubit interaction terms, wherein each decomposition step comprises at least one interaction term comprising less qubits than an interaction term of a previous decomposition step.

4. The method of claim 1, wherein the final decomposition step of the decomposing of the multiqubit interaction terms comprises a final decomposed sequence of steps comprising at least a sequence of three two-qubit interaction terms, said final decomposition step being the last decomposition step done before combining.

5. The method of claim 1, wherein the method additionally comprises obtaining information indicative of native interactions of the quantum device, the method comprising applying single-qubit interactions in connection with two-qubit interactions that do not correspond to native gates of the quantum device to obtain single-qubit and/or two-qubit interactions terms that correspond to native interactions of the quantum device.

6. The method of claim 1, wherein the compression comprises at least two two-qubit gates acting on the same qubits being compressed to a single two-qubit gate.

7. The method of claim 1, wherein the compression comprises at least two two-qubit gates acting on at least one common qubit being compressed to a single qubit gate and a two-qubit gate.

8. The method of claim 1, wherein the step of compression is carried out recursively.

9. The method of claim 1, wherein the compression comprises performing at least one action selected from the group of commuting through, cancelling, shifting, reconstructing or merging into a single two-qubit operator, said action optionally being performed for at least one pair of adjacent one- or two-qubit operators acting on at least one same qubit and/or for adjacent steps acting on qubits.

10. The method of claim 1, wherein the compression comprises at least one action of merging into a single two-qubit operator and/or cancelling, optionally in combination with at least one further action of cancelling, shifting, reconstructing, commuting through or merging into a single two-qubit operator.

11. The method of claim 9, wherein the action of shifting comprises performing at least a shift of an operator to an adjacent step.

12. The method of claim 9, wherein the action of commuting comprises commuting at least two gates.

13. The method of claim 6, wherein the compression comprises an action of reconstructing at least one two-qubit gate and at least one single qubit-gate.

14. The method of claim 1, wherein the plurality of qubit entities comprises at least one subsequent qubit entity, said subsequent qubit entity comprises a single multi-qubit interaction term, wherein the method comprises:
decomposing the subsequent qubit entity to determine a subsequent decomposed sequence of steps acting on qubits of the subsequent qubit entity,
combining the subsequent decomposed sequence with the compressed sequence of steps acting on qubits which has been determined in a previous compression,
compressing the combined sequence of steps, and
determining a final sequence of steps acting on qubits as the compressed sequence of steps acting on qubits determined in the last performed compression.

15. The method of claim 14, wherein the subsequent qubit entity is decomposed using the same decomposition used for the compressed sequence of steps acting on qubits which has been determined in a previous compression.

16. The method of claim 14, where the subsequent qubit entity is decomposed using a different decomposition as the decomposition used for the compressed sequence of steps acting on qubits which has been determined in a previous compression.

17. The method of claim 1, wherein a multi-qubit interaction term involves M qubits and is expressible as a tensor product of Pauli matrices and identifies the qubits to be involved and the types of corresponding Pauli matrices, and wherein the decomposing comprises decomposing a multi-qubit interaction term into a sequence of three interaction terms, a first interaction term described by a unitary e^{iuO} of a primary operator O where u is a coupling strength coefficient of O between the qubits on which the primary operator O acts, a second interaction term described by a unitary e^{iγH} of an auxiliary operator H, and a third interaction term described by a unitary e^{-iuO} of the negative of the primary operator −O, wherein H and O are each a tensor product of at least one or two Pauli matrices,
the method comprising iterative decomposition of interaction terms relating to primary operators and auxiliary operators until the multi-qubit interaction term has been decomposed into a sequence of two-qubit interaction terms, wherein the multi-qubit interaction term of the first decomposition step is described by a unitary e^{iγH}^{_{d}} of the first multi-qubit operator and/or the second multi-qubit operator, where H_{d} refers to the multi-qubit operator being decomposed, and where γ is a coupling strength coefficient of H_{d}, and the multi-qubit interaction term in any subsequent decomposition step(s) relates to a primary operator O or an auxiliary operator H.

18. The method of claim 17, wherein the method comprises:
selecting at least one of the identified qubits as a central qubit,
selecting a first auxiliary operator H as a tensor product of M_{H} Pauli matrices, where each Pauli matrix in the tensor product acts on a different qubit, said qubits selected from those specified by the operator H_{d} and the selection including the at least one central qubit, and where M_{H} is less than the number M of Pauli matrices of the multi-qubit operator being decomposed,
selecting a first primary operator O as a tensor product of M_{O} Pauli matrices, where M_{O} is less than the number of Pauli matrices of the multi-qubit operator being decomposed and where each Pauli matrix in the tensor product acts on a different qubit, said qubits and Pauli matrices of the first primary operator O selected such that at least one qubit involved in the first primary operator O is one of the least one central qubits and H_{d} is proportional to the commutator of the primary operator O and the auxiliary operator H,
selecting the coupling strength coefficient of the primary operator O as u=π/4+a*π where a is an integer, for isolating a single M-body term,
wherein the primary operator O and auxiliary operator H are selected to anticommute, wherein the square of the primary operator O is equal to an identity matrix,
wherein the iterative decomposing comprises repeatedly selecting subsequent primary and auxiliary operators until final primary operators and final auxiliary operators that are tensor products of two Pauli matrices and thus correspond to two-qubit interactions are obtained, wherein the decomposing of a previously determined primary operator O comprises reselecting the central qubit before selecting subsequent primary and auxiliary operators, wherein the central qubit is selected from qubits of the operator that is being decomposed.

19. The method of claim 18, wherein the primary operators at each decomposition step comprise a tensor product of Pauli matrices acting on qubits on a first side of the central qubit in the considered multi-qubit operator and including a Pauli matrix acting on the central qubit, and the auxiliary operators at each decomposition step comprise a tensor product of Pauli matrices acting on qubits on a second side of the central qubit in the considered multi-qubit operator and including a Pauli matrix acting on the central qubit, wherein the Pauli matrix acting on the central qubit in the considered multi-qubit operator is of first type, and the Pauli matrix acting on the central qubit in the primary operator is selected to be of second type, and the Pauli acting on central qubit in the auxiliary operator is selected to be of third type.

20. The method of claim 1, wherein the decomposition of at least one of the multi-qubit interaction terms is carried out a plurality of times in a plurality of alternative decompositions to obtain a plurality of alternative decomposed sequences of steps acting on qubits, wherein the method additionally comprises:
determining a plurality of alternative combined sequences of steps acting on qubits and determining a plurality of alternative compressed sequences of steps acting on qubits, and
selecting as a compressed sequence of steps acting on qubits to be used in subsequent combining and compressing steps or as a compressed sequence of steps acting on qubits to be used as a final sequence of steps acting on qubits, a compressed sequence of steps acting on qubits providing a lowest circuit depth of the plurality of alternative compressed sequences steps acting on qubits.

21. The method of claim 20, wherein the alternative decompositions are carried out by selecting a different qubit as a central qubit and/or selecting different type of Pauli matrix for the primary operator and auxiliary operator at at least one of the iterations in the alternative decompositions.

22. The method of claim 1, wherein the method is used for determining a control sequence for simulating a Hamiltonian operator comprising a plurality of interaction terms corresponding to multi-qubit operators, wherein the plurality of qubit entities comprise at least multi-qubit operators corresponding to the interaction terms of the Hamiltonian operator.

23. The method of claim 1, wherein the method is used for determining a control sequence for simulating a fermionic Hamiltonian, the method further comprising:
obtaining parameters of a fermionic Hamiltonian to be simulated, the parameters comprising at least:
a number of fermionic lattice sites L,
a number of fermionic modes m in the fermionic lattice, and
fermionic operators corresponding to interactions between the fermionic modes m,
projecting the fermionic lattice to the qubit layout of the quantum device such that every fermionic mode is assigned to a qubit of the quantum device, wherein said qubit is referred to as a physical qubit P, wherein the projection between the fermionic modes and the physical qubits is one to one, and wherein a plurality of further qubits of the quantum device are referred to as ancilla qubits A, said ancilla qubits A not being assigned with any fermionic mode,
wherein the physical qubits P and the ancilla qubits A are arranged onto horizontal single lines of the two-dimensional square lattice, each horizontal single line comprising at least one string P′ and at least one ancilla qubit A, wherein each string P′ comprises one or more physical qubits P,
wherein the arrangement of physical qubits P and ancilla qubits A in each single horizontal line of the qubit layout is the same,
associating each physical qubit P with at least one edge operator E and one vertex operator V, comprising:
associating each physical qubit P with a vertex operator Vₚ, wherein Vₚ is a Pauli operator of first type, selected from Pauli operator types X, Y and Z, acting on physical qubit p,
for any pair of physical qubits p and q, which in the horizontal dimension are either direct neighbors without any physical or ancilla qubits between them, or are separated by one or two ancilla qubits, define a horizontal edge operator E_{pq}^{H}, associated with said qubits, wherein E_{pq}^{H} is a product of a number of Pauli operators comprising:
at least two Pauli operators, each of second or third type, selected from Pauli operator types X, Y, and Z, and acting on qubits p and q respectively, and
if any ancilla qubits are present between the physical qubits p and q along the horizontal dimension, additional Pauli operators, each of first type, acting on each of said, if any present, ancilla qubits,
wherein when two horizontal edge operators act on the same qubit q, if the first of the two horizontal edge operators E_{pq}^{H1} acts on the qubit q with a Pauli operator of second type, then the second of the two horizontal edge operators E_{pq}^{H2} acts on the qubit q with a Pauli operator of third type and vice versa,
for any pair of physical qubits p and q, where said physical qubits p and q are direct neighbors in the vertical dimension, and where said pair of physical qubits is adjacent to a pair of ancilla qubits a and b, where said ancilla qubits a and b are direct neighbors in the vertical dimension, said ancilla qubits a and b are arranged adjacent to the qubits p and q respectively, define a vertical edge operator E_{pq}^{V}, associated with said qubits p, q, a, b, wherein E_{pq}^{V} is a product of four Pauli operators, each of second or third type and each acting on one of the qubits p, q, a, b such that each of the four Pauli operators acts on a different qubit, wherein
the Pauli operators acting on the ancilla qubits a and bare of different type,
the Pauli operator acting on the physical qubit p is of the same type as the Pauli operator acting on the physical qubit q and forming a part of the horizontal edge operator acting on at least the physical qubit p and the ancilla qubit a, and similarly the Pauli operator acting on the physical qubit q is of the same type as the Pauli operator acting on the physical qubit q and forming a part of the horizontal edge operator acting at least on the physical qubit q and the ancilla qubit b,
a vertical edge operator is referred to as a first vertical edge operator E_{pq}^{V1} when the ancilla qubits a and b are arranged on a first side of the physical qubits p and q respectively along the horizontal dimension, or as a second vertical edge operator E_{pq}^{V2} when the ancilla qubits a and b are arranged on a second side of the physical qubits p and q along the horizontal dimension,
wherein when two vertical edge operators act on the same ancilla qubit, if one of the two vertical edge operators acts on said ancilla qubit with a Pauli operator of second type, then the other of the two vertical edge operators acts on said ancilla qubit with a Pauli operator of third type and vice versa
mapping each fermionic operator to a qubit operator based on the edge operators E and vertex operators V, wherein at least one of the determined qubit operators is utilized as a second qubit entity.

24. A computer program product comprising program code means adapted to execute the method according to claim 1 when run on a computer.

25. A quantum circuit comprising a sequence of qubit interactions determined according to the method of claim 1.

26. A method for determining at least one characteristic of a system, the method comprising:
determining a many-body interaction problem related to a system, wherein at least one characteristic of the system is characterized by said many-body interaction problem,
determining a control sequence according to claim 1,
implementing said determined control sequence on a quantum device comprising at least M qubits, and applying a measurement gate to determine the characteristic of the system.
